(19) United States
(12) Patent Application Publication
(10) Pub. No.: US 2013/0091562 A1
(43) Pub. Date: Apr. 11, 2013

(54) COMPUTER

(71) Applicants: Keiichi Matsuzawa, Yokohama (JP); Masaaki Iwasaki, Tachikawa (JP)

(72) Inventors: Keiichi Matsuzawa, Yokohama (JP); Masaaki Iwasaki, Tachikawa (JP)

(73) Assignee: Hitachi, Ltd.

(21) Appl. No.: 13/264,904

(22) PCT Filed: Oct. 5, 2011
(86) PCT No.: PCT/JP2011/005614

§ 371 Date: Oct. 17, 2011

(51) Int. Cl. G06F 12/14; G06F 21/00

(52) U.S. Cl. 726/17

(57) ABSTRACT

It is an object of the present invention to provide a technique for managing, in a file system that stores past images of a data file, access right to the past images.

A computer according to the present invention includes a past access control list in which access right of a user to past images and a period in which the access right is applied are described and validates accessibility to the past images using the past access control list (see FIG. 5).

### TECHNICAL FIELD

The present invention relates to access right management in a computer.

### BACKGROUND ART

Currently, according to demands by laws and conversion into electronic form of information referred to for a long period such as medical and pension information, there is increasing necessity for storing electronic data over a long term. Therefore, in order to realize the long-term storage of the electronic data, various techniques have been developed in respective layers of hardware, software, an operation management system, and the like.

Examples of a technique for storing electronic data for a long term include, in the hardware, a RAID (Redundant Array of Independent Disks) for multiply writing data in plural media to reduce possibility of a data loss and a Scrubbing technique for periodically reading data of a physical medium and checking an error. Examples of the technique include, in the software, a WORM (Write Once Read Many) technique for preventing falsification of created data, a Versioning technique for keeping a data change history in the past, and a Snapshot technique for keeping data at a specific point in the past. Examples of the technique include, in the operation management system, a backup technique for copying data to another storage medium and a remote replication technique for copying data among plural apparatuses arranged in remote locations.

According to these technological innovations, data can be stored for a long term. Concerning data tied to the same name, according to the techniques such as Snapshot, Versioning, and backup, data at a point in the past can be stored and extracted later. The data at the point in the past stored by these techniques is referred to as past image below.

An organization/a person that manages data for a long term is not always the same throughout a data storage period. It is considered to be substantially likely that an organization/a person that carries out data management changes because of a factor such as reorganization or personnel changes. What matters is management of access right to data. For example, when a person having access right to data at a point when the data is generated currently belongs to a different organization because of personnel changes or the like, depending on a demand of a law or an organization, it is likely that the user must not be permitted to access the data.

In this way, when it is attempted to appropriately manage access right to data on the basis of a demand of a law or an organization, a technique that can manage access right to past images is necessary. In particular, in an environment in which a large number of past images associated with the same name are present according to the Snapshot technique or the like, a technique for managing access right to the past images is necessary.

In general, data is stored on a file system. In the file system, a set of data affixed with a name is referred to as file and the data is managed according to the name of the file. In order to manage access right to the file, in general, information managed by the file system itself and attribute information of a user who uses the file system are used. The information managed by the file system includes file owner information, Permission bits, and an ACL (Access Control Lists). A system for managing the attribute information of the user includes a uid/gid system, X.500, and Active directory.

Patent Literature 1 proposes, in a file system environment including a Snapshot function, a system for deleting data including Snapshot in the past taking into account the structure of Snapshot.

Patent Literature 2 proposes a system for giving period information to user attribute information. This makes it possible to designate access right of a user for each period. However, since this system is a system concerning user attribute information, although user attribute information in the past is managed, access right to a past image is not managed.

### CITATION LIST

### Patent Literature

PTL 1: JP Patent Publication (Kokai) No. 2010-33374
PTL 2: JP Patent Publication (Kokai) No. 2005-258886

### SUMMARY OF INVENTION

### Technical Problem

In an access validation system adopted in a file system in a present state, in some case, access right to a past image cannot be correctly validated. For example, in a file system for carrying out access validation using an ACL, when access right of a user not present any more because of personnel changes or the like is deleted from the present file, although access right information is deleted from an ACL associated with the present file image, the access right information remains as it is in an ACL of a past image.

As a result, although the user cannot access the present file image, the user can still access the past image. However, depending on a demand of a law or the like, it is conceivable that access to the past image should be prohibited. In the system for managing access right using an ACL, it is difficult to cope with such a case.

In the technique described in Patent Literature 1, since access right management for a file is not referred to, it is considered difficult to cope with the situation explained above.

In the technique described in Patent Literature 2, although access control can be performed using only user attribute information held by a user in the past, it is considered difficult to perform access control taking into account access right to past images.

The present invention has been made to solve the problems described above and it is an object of the present invention to provide a technique for managing, in a file system that stores past images of a data file, access right to the past images.

### Solution to Problem

A computer according to the present invention includes a past access control list in which access right of a user to past images and a period in which the access right is applied are described and validates accessibility to the past images using the past access control list.

### Advantageous Effects of Invention

With the computer according to the present invention, it is possible to validate, on the basis of access right to a past image held by a user at a point in the past, accessibility to the past image.

### BRIEF DESCRIPTION OF DRAWINGS

FIG. 1 is a diagram of a computer system 1000 according to a first embodiment.

FIG. 2 is a functional block diagram of a file server 100.

FIG. 3 is a functional block diagram of a user attribute information server 200.

FIG. 4 shows an internal configuration of a host computer 400.

FIG. 5 is a diagram showing reference relations of reference to a file and a past image by programs of the file server 100.

FIG. 6 is a diagram showing a configuration example of an ACL 514 included in present file information 510.

FIG. 7 is a diagram showing a configuration example of user attribute information 223.

FIG. 8 is a diagram showing a processing flow in which the file server 100 validates accessibility to a past image stored by the file server 100 when the host computer 400 issues an access request to the past image.

FIG. 9 is a diagram showing screen examples of an ACL setting screen 910 and an ACL editing screen 920 used for changing a file access right.

FIG. 10 is a diagram showing a processing flow for changing the ACL 514.

FIG. 11 is a diagram showing an example in which information concerning access right is displayed or changed according to a command input.

FIG. 12 is a diagram showing a processing flow for changing access right according to a command explained with reference to FIG. 11.

FIG. 13 is a diagram showing reference relations of reference to a file and a past image by computer programs of the file server 100 in a second embodiment.

FIG. 14 is a diagram showing a configuration example of the ACL 514 in the second embodiment.

FIG. 15 is a diagram showing a processing flow in which the file server 100 validates accessibility to past images stored by the file server 100 when the host computer 400 issues an access request to the past images.

FIG. 16 is a diagram showing a processing flow for changing an ACL 524.

FIG. 17 is a diagram showing a method in which a past image access program 123 updates past images using AoW or CoW.

FIG. 18 is a diagram showing a processing flow of an access right change for preventing an amount of use of a storage area from being increased every time an ACL is changed when the AoW or the CoW is used.

FIG. 19 is a diagram showing reference relations of reference to a file and a past image by computer programs of the file server 100 in a second embodiment.

FIG. 20 is a diagram showing a processing flow at the time when the host computer 400 requests access to past images on the file server 100.

FIG. 21 is a processing flowchart of an access validation sub-flow 2100 carried out in steps S2005 and S2010 of FIG. 20.

FIG. 22 is a diagram showing a configuration example of a score table 2200 used when a validation result of access to a present image and a validation result of access to past images are different.

FIG. 23 is a diagram showing a configuration example of an ACL updatability table 2300.

FIG. 24 is a diagram showing a processing flow for changing access right in a fourth embodiment.

FIG. 25 is a diagram showing a state in which a file list in a folder stored by the file server 100 is screen-displayed on the host computer 400.

FIG. 26 is a diagram showing a processing flow for generating a virtual file list view.

FIG. 27 is a diagram showing a screen display example of a virtual file list view 2700.

### DESCRIPTION OF EMBODIMENTS

### First Embodiment

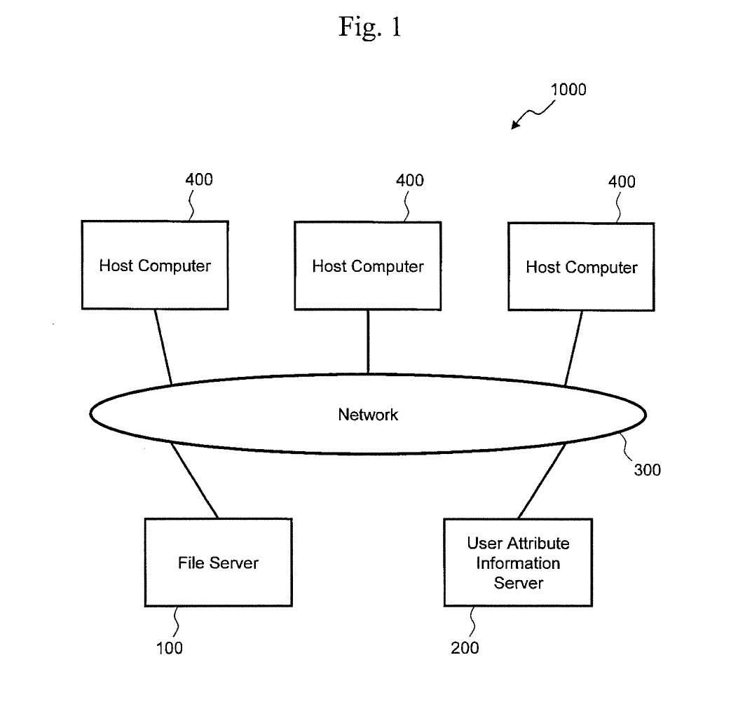

FIG. 1 is a diagram of a computer system 1000 according to a first embodiment of the present invention. The computer system 1000 includes a file server 100, a user attribute information server 200, and a host computer 400. These computers are connected to one another via a network 300.

The file server 100 is a server that stores a data file used by the host computer 400. The file server 100 provides a control function for access to a file on the basis of access right held by a user of the host computer 400.

The user attribute information server 200 is a server that manages attribute information of the user who uses the host computer 400. When the user logs in to the host computer 400, the host computer 400 acquires attribute information of the user from the user attribute information server 200. The file server 100 validates access right held by the user on the basis of this user attribute information.

As the network 300, an IP (Internet Protocol) network, a NetBIOS network, or the like can be used. A connection form may be either wired connection or wireless connection.

The number of servers and the number of computers are arbitrary. One server or computer may play functions of other servers or computers as well.

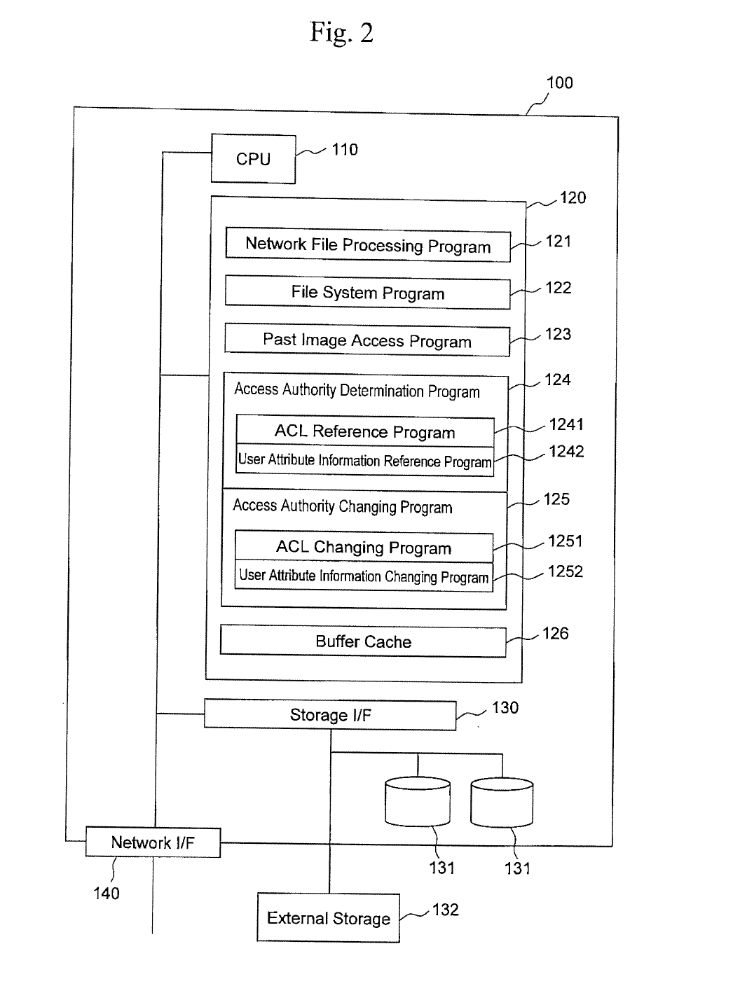

FIG. 2 is a functional block diagram of a file server 100. The file server 100 includes a CPU (Central Processing Unit) 110, a memory 120, a storage interface 130, and a network interface 140.

The CPU 110 controls the operation of the file server 100 by executing programs stored by the memory 120.

The memory 120 stores a network file processing program 121, a file system program 122, a past image access program 123, an access right validation program 124, and an access right changing program 125. The CPU 110 can use a space area of the memory 120 as a buffer cache 126 of a storage medium 131 and an external storage 132 explained later and make use of the buffer cache 126 in order to reduce a processing delay of the storage medium 131 and the external storage 132.

The network file processing program 121 is a program for enabling the host computer 400 to use a data managing function in a file unit provided by the file system program 122. Examples of a program equivalent to the network file processing program 121 include an NFS server program and a CIFS server program.

The file system program 122 is a program configuring a file system that manages data in a file unit. In general, on the file system, a file is managed with management information such as a name, metadata, and ACL information added to a data section. The metadata can include information such as a creator, a last updater, file creation date and time, and data length of the file. An ACL includes information used for access right validation such as Permission bit, and ACE (Access Control Entry). The file system program 122 associates these kinds of management information with a data body and then stores the management information in the storage medium 131 and the external storage 132. Examples of the file system program 122 include programs configuring the file system such as ext3 (third extended file system), NTFS (NT File System), XFS, and FAT (File Allocation Table). The file system program 122 may be configured as an independent program or may be configured as a part of an OS (Operating System).

The past image access program 123 is a program for referring to or changing a file image at a point in the past according to a request from the CPU 110. The past image access program 123 can refer to or change images, metadata, and ACL information at a point in the past of files in association with the file system program 122.

A system for realizing the past image access program 123 is publicly known. Examples of the system include a snapshot system for storing a state of an entire file system at a certain point and extracting the state later, a versioning system for cumulatively storing data before update during file update, and a backup system for periodically copying data mainly to the external storage 132. Plural layers implemented with a system for accessing a past image are also conceivable. For example, a system for storing past data in the file system and a system for storing past data in the external storage 132 are conceivable. All of these systems make it possible to store information of a file system or a file at a point in the past and refer to the information later.

Data (including metadata and an ACL) at a point in the past of a file provided by the past image access program 123 and the file system program 122 is referred to as past image.

The access right validation program 124 is a program for validating, when there is a file access request to the network file processing program 121 from the host computer 400, whether the request is permitted or denied. When the request is denied, the host computer 400 cannot access the file.

The access right validation program 124 includes an ACL reference program 1241 and a user attribute information reference program 1242 on the inside. The ACL reference program 1241 is a program for acquiring, referring to an ACL associated with a file, access right information held by a user for the file. The user attribute information reference program 1242 is a program for acquiring attribute information of a user who accesses a file. The attribute information of the user is stored on the user attribute information server 200. The same information can also be cached on the file server 100.

The access right changing program 125 is a program for rewriting, when a request for changing access right is made to the network file processing program 121, an access control list according to the request for the change.

The access right changing program 125 includes an ACL changing program 1251 and a user attribute information changing program 1252 on the inside. The ACL changing program 1251 is a program for updating an ACL according to a request. The user attribute information changing program 1252 is a program for updating attribute information of a user according to a request.

The storage interface 130 stores data in the storage medium 131 or the external storage 132 or refer to the data on the basis of a request from the CPU 110. As the storage medium 131, an optical disk, a magnetic disk, a flash storage, or the like can be used. A RAID technique for binding plural storage media and showing the storage media as a single storage medium can also be used. In this case, for communication between the storage interface 130 and the storage medium 131, a standard such as ATA (AT Attachment interface), SATA (Serial ATA), or SCSI (Small Computer System Interface), SAS (Serial Attached SCSI) is used. The storage interface 130 can store data in the external storage device 132 or refer to the data. In this case, as the external storage 132, for example, a storage array including a large number of tape devices and magnetic disks and including a controller that controls the tape devices and the magnetic disks can be used. In this case, for communication between the storage interface 130 and the external storage medium 132, a communication standard such as Fibre Channel or PCI (Peripheral Component Interconnect) Express is used.

The network interface 140 communicates with the host computer 400 and the user attribute information server 200 via the network 300 and transmits and receives a file access request and user attribute information on the basis of a request from the CPU 110. The network interface 140 can also include a function of the storage interface 130. In that case, a communication standard such as iSCSI or FCoE (Fibre Channel over Ethernet) is used.

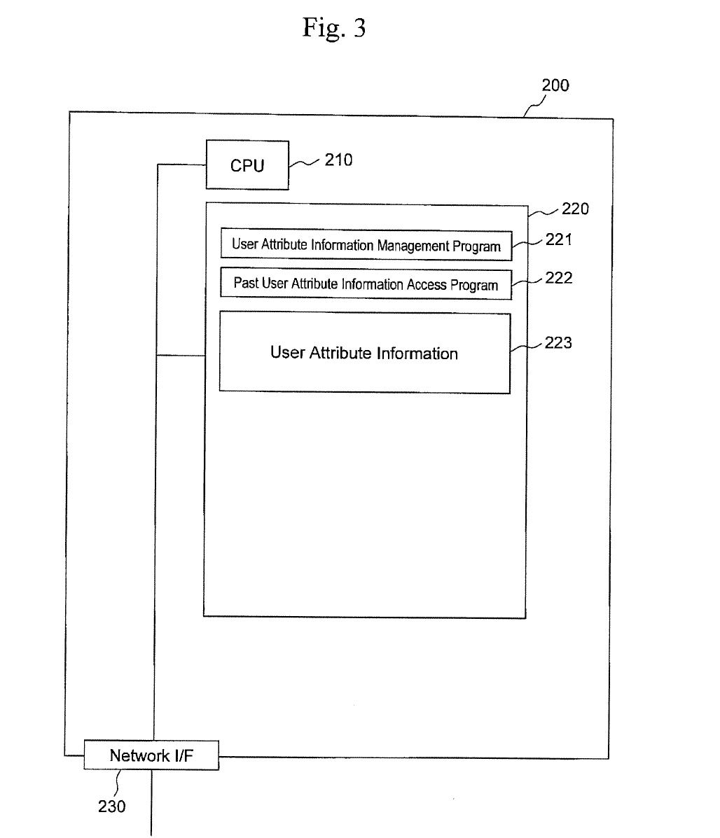

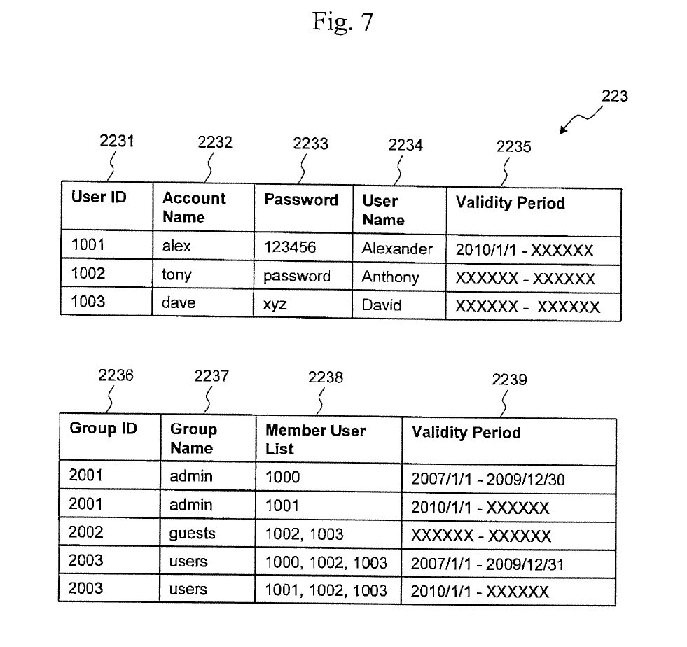

FIG. 3 is a functional block diagram of the user attribute information server 200. User attribute information is information such as a user ID, a login password, and a validity period. Details are explained with reference to FIG. 7 later. The user attribute information server 200 includes a CPU 210, a memory 220, and a network interface 230.

The CPU 210 controls the operation of the user attribute information server 200 by executing programs stored by the memory 220. The network interface 230 includes a function same as the function of the network interface 140 included in the file server 100.

The memory 220 stores a user attribute information management program 221, a past user attribute information access program 222, and user attribute information 223.

The user attribute information management program 221 is a program for returning the user attribute information 223 and updating the user attribute information 223 according to a request from an external computer. The past user attribute information access program 222 is a program for referring to or changing user attribute information at a point in the past. The user attribute information 223 stores attribute information such as a user ID and a password. Details are explained with reference to FIG. 7 later.

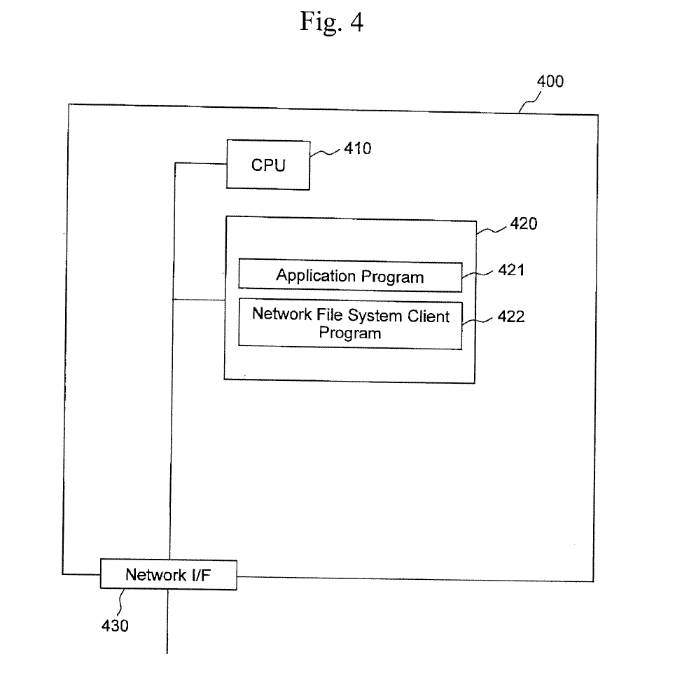

FIG. 4 shows an internal configuration of the host computer 400. The host computer 400 includes a CPU 410, a memory 420, and a network interface 430.

The CPU 410 controls the operation of the host computer 400 by executing programs stored by the memory 420.

The memory 420 stores an application program 421 and a network file system client program 422.

The application program 421 is a program for carrying out an operation expected by the user of the computer system 1000 using data provided by the file server 100. The network file system client program 422 communicates with the file server 100 via the network 300 and refers to or changes a file and a past image stored by the file server 100.

The network interface 430 is an interface that communicates with other computers via the network 300. Examples of a communication protocol between the network interface 430 and the other computers include an IP (Internet Protocol), a TCP (Transmission Control Protocol), and a NetBEUI (NetBIOS Extended User Interface). Examples of the file system that refers to or changes a file via the network 300 include an NFS (Network File system) and a CIFS (Common Internet File system).

In the following explanation, for convenience of explanation, programs are described as operation entities. However, it should be noted that what actually executes these programs is an arithmetic unit such as a CPU.

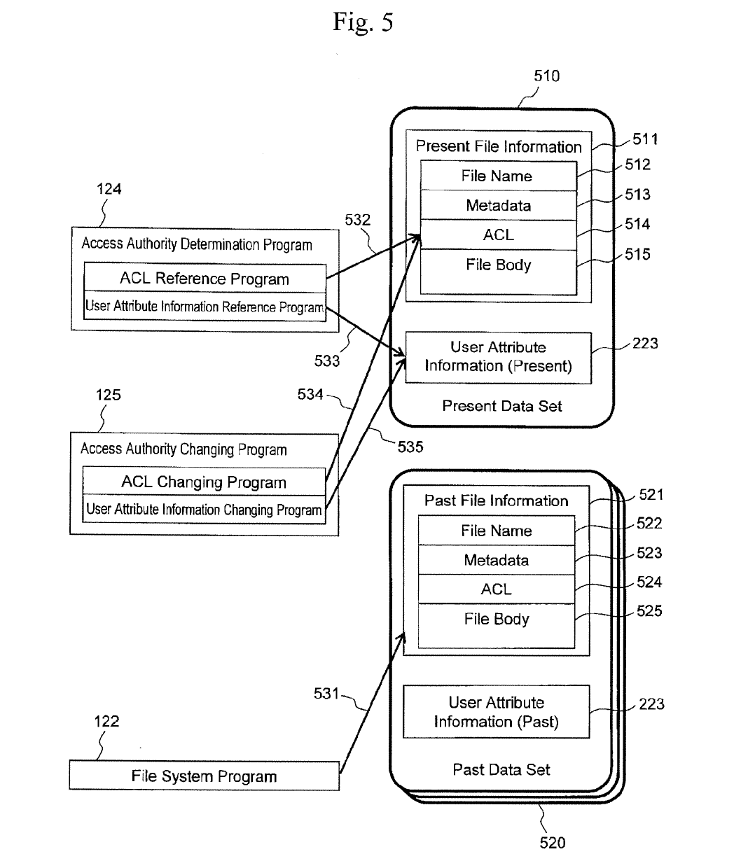

FIG. 5 is a diagram showing reference relations of reference to a file and a past image by the programs of the file server 100. In FIG. 5, both of a present file and a past image of the present file are shown. A set of the present file and management information related to the present file is referred to as present data set 510. A set of the past image and management information related to the past image is referred to as past data set 520.

The present data set 510 includes present file information 511 and the user attribute information 223 at the present point stored by the computer system 1000 in operation. The present file information 511 is information concerning a file managed by the file system program 122 of the file server 100. In FIG. 5, only one piece of the present file information 511 is described. However, actually, pieces of the present file information 511 equivalent to the number of files are present.

The present file information 511 includes a file name 512, metadata 513, an ACL 514, and a file body 515. The file name 512 is a name of the file on a file system. The metadata 513 is management information such as a creator of the file. The ACL 514 is data in which access right of a user to the file is described. The file body 515 is a data body of the file. These data are stored after being associated on the file system of the file server 100.

The user attribute information 223 included in the present data set 510 is attribute information at the present point of the user provided by the user attribute information server 200. The user attribute information 223 is not data stored on the file server 100. However, since the user attribute information 223 is necessary for validating access right to a file, in explanation, the user attribute information 223 is included in the present data set 510.

The past data set 520 includes past file information 521 and the user attribute information 223 at a certain point stored by the computer system 1000 in the past. In some case, plural past data sets 520 are present according to an update history of a file.

The past file information 521 is management information of a file at a certain point in the past provided by the file system program 122 and the past image access program 123 of the file server 100. Reference relation 531 shown in FIG. 5 indicates a state in which the file system program 122 refers to the past file information 521.

Like the present file information 511, the past file information 521 includes a file name 522, metadata 523, an ACL 524, and a file body 525. These data are stored after being associated on the file system of the file server 100.

The user attribute information (past) 223 is attribute information of a user at a point in the past provided by the user attribute information management program 221 and the past user attribute information access program 222 of the user attribute information server 200. The user attribute information in the past is attribute information of the user at a point corresponding to date and time of the past data sets 520. Because of the same reason as the user attribute information 223 included in the present data set 510, the user attribute information 223 is included in the past data set 520 as well.

Reference relations 532 to 533 indicate a state in which the access right validation program 124 refers to the present data set 510. Reference relations 534 to 535 indicate a state in which the access right changing program 125 updates the present data set 510.

In the first embodiment, in the ACL 514 included in the present file information 510, access right of a user to past images is described together with an application period of the access right in addition to access right of the user to a present file. In other words, in order to refer to or update the access right of the user to the past images, the ACL 514 in the present data set 510 only has to be referred to or updated.

In this regard, since the ACL 524 at points in the past is included in the past data set 520 as well, it seems that the ACL 524 only has to be directly referred to or updated. However, in some case, the past file information 521 is stored on a storage medium that cannot be overwritten such as a backup medium. Further, in some case, the past file information 521 is prohibited from being updated according to a demand of a law or the like. Therefore, in the first embodiment, access right of the user at a point in the past is described in the ACL 514 of the present file information 510.

The ACL 514 corresponds to “present access control list” in the first embodiment. The ACL 524 corresponds to “past access control list”. The file server 100 corresponds to “computer”.

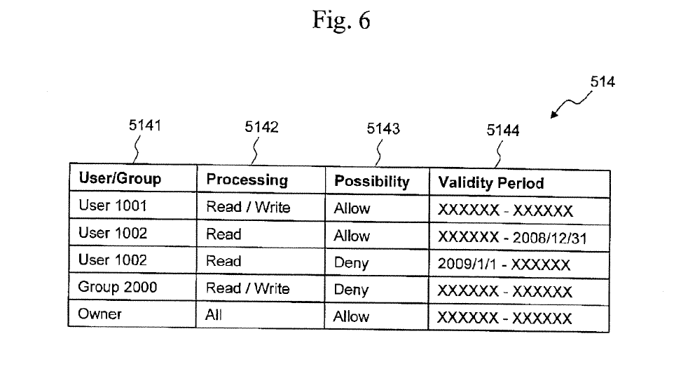

FIG. 6 is a diagram showing a configuration example of the ACL 514 included in the present file information 510. The ACL 514 includes a user/group field 5141, a processing field 5142, a possibility field 5143, and a validity period field 5144. The ACL 524 included in the past file information 520 has the same configuration (a user/group field 5241, a processing field 5242, a possibility field 5243, and a validity period field 5244).

The user/group field 5141 stores a user name or a group name to be subjected to access control. The user name or the group name can be described using a code that can uniquely specify a user or a group, for example, a name or an ID. In the user/group field 5141, besides information for directly designating a user or a group, information that can specify a user or a group from the metadata 513 may be used. For example, in a data example shown in a fifth row of FIG. 6, access right to a file owner is described. Similarly, as information stored in this field, examples such as a file creator, a person who sets a file system, and an owner of a higher-order folder are conceivable.

The processing field 5142 indicates a type of a processing request for a file. For example, besides reading/writing of the file, processing types such as execution, deletion, and a name change of the file and a change of metadata are stored in this field.

The possibility field 5143 stores a value for designating whether a user designated by the user/group field 5141 is permitted to carry out processing shown in the processing field 5142.

The validity period field 5144 indicates a period in which records in the ACL 514 are applied. If the records are valid at the present point, an end period is not designated. In this field, actual time may be stored or a version number of a past image supporting a versioning function may be input. Indefinite can also be designated. For example, since both start date and time and end date and time of this field are not described in a record in a first row, this indicates that the record is valid in the entire period. It is indicated that a record in a second row is valid before Dec. 31, 2008. This field can designate a point in the future after the present point. This field does not always have to be present. In that case, the record is regarded as valid in the entire period.

FIG. 7 is a diagram showing a configuration example of the user attribute information 223. Examples of user information, which is attribute information of an individual user, and group information, which is attribute information of a group to which the user belongs, are shown.

The user information has a user ID field 2231, an account name field 2232, a password field 2233, a user name field 2234, and a validity period field 2235. User attribute information other than these kinds of information also can be stored. In the attribute information of the user, a validity period is also set by the validity period field 2235 as in the ACL. Therefore, not only attribute information of a present user but also attribute information of a user present at a point in the past, attribute information at a point in the past of a currently-present user, and the like can be stored in the user attribute information 223.

The group information has a group ID field 2236, a group name field 2237, a member user list field 2238, and a validity period field 2239. Group attribute information other than these kinds of information can also be stored. In the member user list field 2238, a value of the group ID field 2236 in another record may be stored. In the attribute information of the group, a validity period is also set by the validity period field 2239 as in the ACL. Therefore, not only attribute information of a present group but also attribute information of a group present at a point in the past, attribute information at a point in the past of a currently-present group, and the like can be stored in the user attribute information 223.

In the example shown in FIG. 7, users belonging to a group are managed by the member user list field 2238. However, another management method may be used as long as correspondence between group IDs and user IDs is understood. For example, a list of group IDs to which users belong may be stored in user information or a list different from a table shown in FIG. 7 may be created and correspondence relations between group IDs and user IDs may be listed.

When a user ID, a group ID, and a certain point at present or in the past are designated, it is necessary that values of the user ID, the group ID, and the certain point can be uniquely specified. Specifically, records having the same user ID and the same group ID and having overlapping validity periods must not be present in the user attribute information 223.

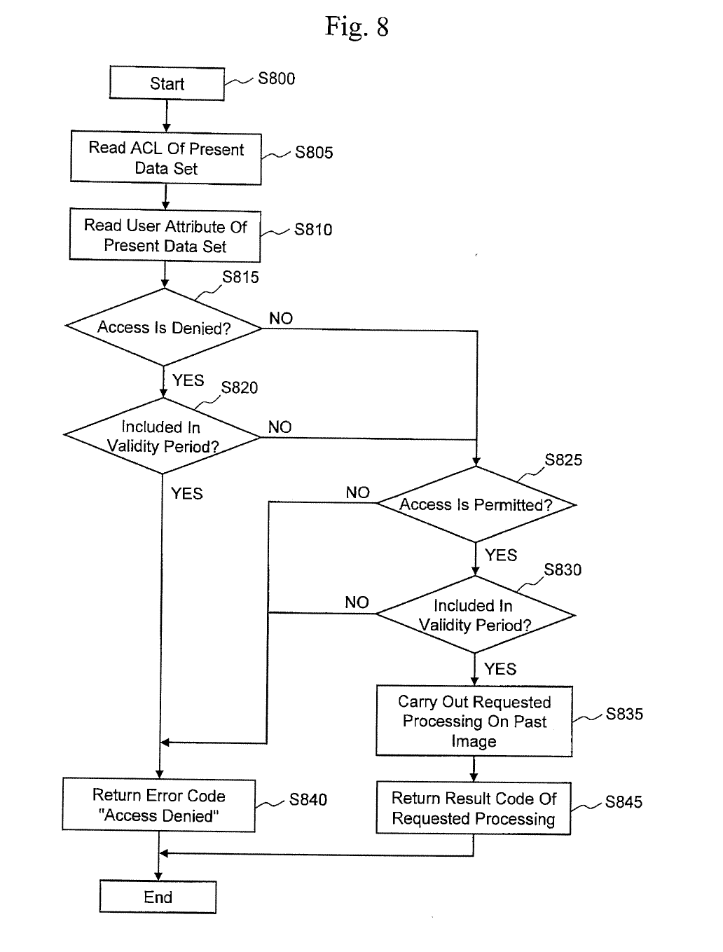

FIG. 8 is a diagram showing a processing flow in which the file server 100 validates accessibility to a past image stored by the file server 100 when the host computer 400 issues an access request to the past image. Steps shown in FIG. 8 are explained below.

(FIG. 8: Step S800)

When a request for accessing a past image is sent from the host computer 400 to the file server 100, the file system program 122 inquires the access right validation program 124 about accessibility to the past image. The access right validation program 124 executes a processing flow explained below.

(FIG. 8: Steps S805 to S810)

The ACL reference program 1241 acquires the ACL 514 of a file, an access request to which is received, from the present data set 510 (S805). The user attribute information reference program 1242 acquires, referring to the user attribute information 223 of the present data set 510, user information matching a user ID of a user who issues the access request to the past image and a point set as a request target and further acquires group information to which the user ID belongs at the point set as the request target (S810).

(FIG. 8: Step S815)

The access right validation program 124 validates, using the ACL 514 and the user attribute information 223 obtained in steps S805 to S810, whether the file access is denied. Specifically, the access right validation program 124 searches for, in the ACL 514, a record that has the user who accesses the file or a group to which the user belongs in the user/group field 5141 and in which requested processing coincides with the processing field 5142 and the possibility field 5143 is Deny. When no relevant record is present, the access right validation program 124 proceeds to step S825. When a relevant record is present, the access right validation program 124 proceeds to step S820.

(FIG. 8: Step S820)

The access right validation program 124 checks whether the validity period field 5144 of the record satisfying the conditions in step S815 includes a point when access is requested. When the validity period field 5144 includes the access target point, the access right validation program 124 proceeds to step S840. When the validity period field 5144 does not include the access target point, the access right validation program 124 proceeds to step S825.

(FIG. 8: Step S820: Supplementation)

In this step, when the validity period field 5144 includes the access target point, deny entry of the ACL 514 is applied. At that point, the user does not have an access right to past images. When the validity period field 5144 itself is absent, the ACL is regarded as valid in the entire period. Therefore, if an ACL record satisfying the conditions in step S815 is present, access to the past images is always denied. When the validity period field 5144 is described in the form of, for example, a version number other than actual time, the access right validation program 124 validates, according to a version number at a point in the past when access is requested rather than actual time at the point in the past, whether the access target point is included in the validity period.

(FIG. 8: Step S825)

The access right validation program 124 validates whether file access is permitted or denied using the ACL 514 and the user attribute information 223 obtained in step S805 to S810. A specific procedure is the same as step S815 except that a record in which the possibility field 5143 is Allow is searched. When the access is permitted, the access right validation program 124 proceeds to step S830. When the access is not permitted, the access right validation program 124 proceeds to step S840.

(FIG. 8: Step S830)

The access right validation program 124 checks whether the validity period field 5144 of the record satisfying the conditions in step S825 includes the access target point of the past image. When the validity period field 5144 includes the access target point, the access right validation program 124 proceeds to step S835. When the validity period field 5144 does not include the access target point, the access right validation program 124 proceeds to step S840.

(FIG. 8: Step S830: Supplementation)

In this step, when the validity period field 5144 includes the access target point, allow entry of the ACL 514 is applied. It is regarded that the user is permitted to access past images at that point. When the validity period field 5144 does not include the access target point, access is denied. When plural ACL records satisfy the conditions in steps S825 and S830, if there is at least one ACL record satisfying the conditions of both steps S825 and S830, the access right validation program 124 proceeds to step S835. When no ACL record satisfying the conditions of both steps S825 and S830 is present, the access right validation program 124 proceeds to step S840.

(FIG. 8: Steps S835 to S845)

The file system program 122 carries out requested processing for the past file information 521 (S835). The processing of step S835 is equivalent to the reference relation 531 shown in FIG. 5. The file system program 122 returns a result code indicating a processing result in step S835 to the host computer 400.

(FIG. 8: Step S840)

The file system program 122 returns an error code indicating that access is denied to the host computer 400.

With the processing flow shown in FIG. 8, when the user of the host computer 400 requests access to a past image, accessibility can be validated according to a point set as the request target. Accessibility is validated using the validity period field 5144 stored by the ACL 514, whereby, even when access right of the user is different for each point set as the request target, it is possible to appropriately validate accessibility.

The procedure for validating access right to a past image is explained above. Next, a procedure for changing access right to a past image is explained.

As explained with reference to FIG. 8, access right to a past image is validated by the ACL 514 and the user attribute information 223 included in the present data set 510. Therefore, in order to change file access right, it is necessary to change the ACL 514 and the user attribute information 223. The user attribute information 223 only has to be changed according to a known changing procedure. Specifically, the user attribute information changing program 1252 corrects the user attribute information 223 according to a changing instruction from the user. The processing is indicated by the reference relation 535 shown in FIG. 5. A procedure in which the ACL changing program 1251 corrects the ACL 514 is explained below.

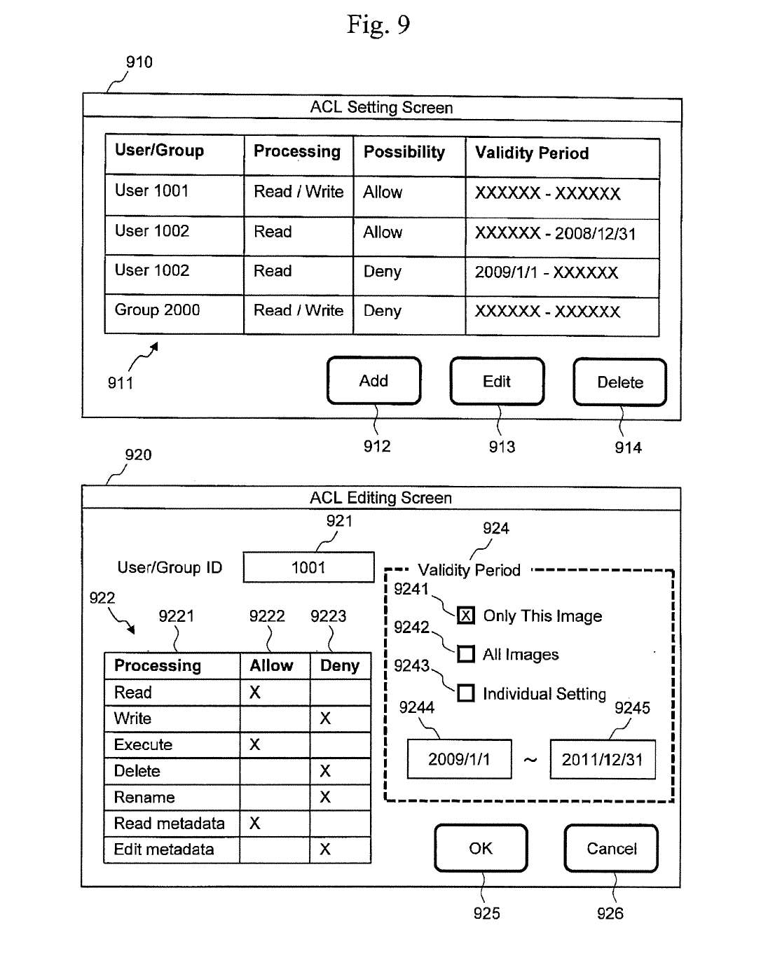

FIG. 9 is a diagram showing screen examples of an ACL setting screen 910 and an ACL editing screen 920 used for changing a file access right. These screens can also be displayed, for example, when a screen for viewing properties of a file is displayed on the host computer 400.

The ACL setting screen 910 includes an ACL list display space 911, an ACE addition button 912, an ACE editing button 913, and an ACE deletion button 914. The ACL list display space 911 is a space in which contents of the ACL 514 are displayed as a list. The user can select one or more ACL records (ACEs) using an input device such as a keyboard or a mouse. When the user presses the ACE addition button 912 or selects the ACE editing button 913 in a state in which any entry is selected in the ACL list display space 911, the ACL editing screen 920 is displayed. When the user selects the ACE deletion button 914 in a state in which any entry is selected in the ACL list display space 911, the selected entry is deleted. In order to add, edit, or delete an ACE, the user has to have access right to the ACL 514. For example, in an NTFS file system, access right information concerning such ACL editing right can be stored on a file system.

The ACL editing screen 920 is a screen used for editing one ACE. A user/group ID space 921 is a space for displaying or editing the user/group information field 5141. A right-by-file-request list 922 is a space for displaying or selecting a permission flag 9222 or a denial flag 9223 for each file request type 9221. In this space, the user can display or edit a processing field 5142 or a possibility field 5143. A validity period space 924 is a space for designating a period in which setting contents of the ACL editing screen 920 are applied. Information equivalent to a validity period field 5144 can be displayed or edited. An item 9241 designates that an ACL is applied for only an image in which the ACL editing screen 920 is displayed. When the item 9241 is selected, access right set on the ACL editing screen 920 is applied to only an image in which the ACL editing screen 920 is invoked. An item 9242 designates that the access right set on the ACL editing screen 920 is applied to ACLs of all images in the past. When the item 9242 is selected, access right set on the ACL editing screen 920 is applied to file images at all points at present, in future, and in the past. An item 9243 designates that the user of the computer system 1000 sets access right more in detail. When the item 9243 is selected, a period in which access right information set on the ACL editing screen 920 is applied is designated in editing spaces 9244 and 9245. The editing space 9244 is a space for designating a start date of the application period. The editing space 9245 is a space for designating an end date of the application period. A method of describing the application period may be other methods. For example, the application period may be designated by a version number of a past image of a file. After an ACE is edited on the ACL editing screen 920, when the user of the computer system 1000 selects an OK button 925, contents of access right after change is notified to the access right correcting program 125. In addition, a validity period of an image can be set by means other than the validity period space 924. For example, the initial setting of the access right changing program 125 may validate whether the applied range of access right would be limited only to images that are displayed in the ACL editing screen 920, to all of periods, or to a specific period.

When the ACL setting screen 910 and the ACL editing screen 920 are requested to be displayed for a past image of a file, contents of the ACL 514 stored in the present data set 510 rather than the ACL 524 at a point in the past are displayed. Consequently, it is possible to change the present ACL 514 used for actually carrying out access right validation.

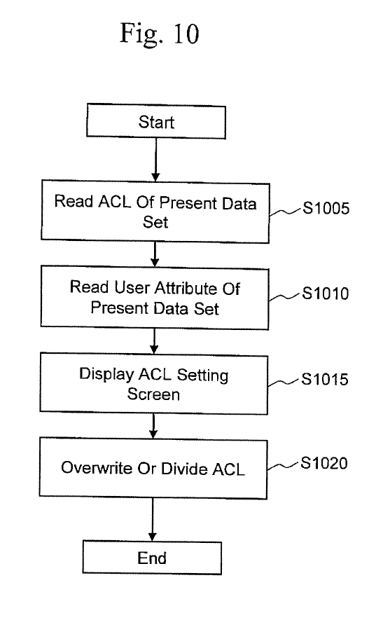

FIG. 10 is a diagram showing a processing flow for changing the ACL 514. This processing flow is executed by the ACL changing program 1251 when the user of the computer system 1000 changes an ACL. Steps shown in FIG. 10 are explained below.

(FIG. 10: Steps S1005 to S1010)

First, the ACL changing program 1251 acquires the ACL 514 of the present data set 510 (S1005). Subsequently, the ACL changing program 1251 acquires the user attribute information 223 via the user attribute information reference program 1242 (S1010).

(FIG. 10: Step S1010: Supplementation)

Step S1010 is not a step directly used for processing itself for changing the ACL 514. However, for example, attribute information of a user or a group acquired in this step is presented to the user, whereby it is possible to facilitate work of the user for setting the ACL 514.

(FIG. 10: Steps S1015 to S1020)

The ACL changing program 1251 displays the ACL setting screen 910 and the ACL editing screen 920 and urges the user to change an ACL (S1015). When the user changes the ACL on the ACL setting screen 910 and the ACL editing screen 920, the ACL changing program 1251 applies overwriting of an entry instructed to be changed in the ACL 514 to the ACL 514 (S1020).

(FIG. 10: Step S1020: Supplementation)

When the validity period field 5144 is changed, an ACE may be divided. For example, concerning an ACE, a validity period of which is 2008/01/01 to 2010/12/31, when the user reduces the validity period to 2008/01/01 to 2009/12/31 on the ACL editing screen 920, another ACE may be created for the period of 2010/01/01 to 2010/12/31 excluded from the original ACE and the original user/group field 5141, processing field 5142, and possibility field 5143 may be copied in the ACE. Alternatively, the validity period field 5144 may be simply reduced to 2008/01/01 to 2009/12/31. As a result, access right information in the period of 2010/01/01 to 2010/12/31 may be lost. Which of the methods is selected may depend on initial setting of the access right changing program 125 or an item for selecting a method may be provided on the ACL editing screen 920.

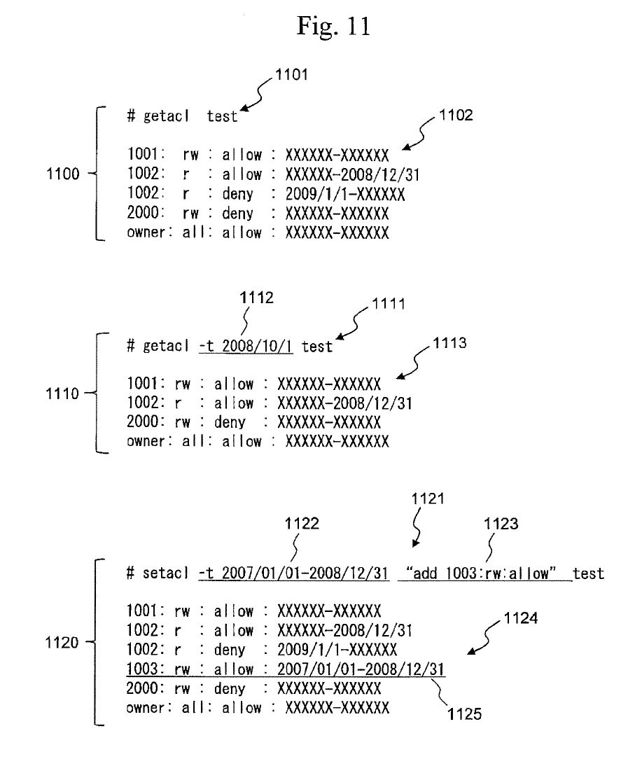

FIG. 11 is a diagram showing an example in which information concerning access right is displayed or changed according to a command input. Command examples 1100 and 1110 for displaying the ACL 514 and a command example 1120 for changing the ACL 514 are shown.

The command example 1100 indicates an example in which the ACL example shown in FIG. 6 is displayed according to a command input. A command 1101 is an example of a getacl command for instructing to display the ACL 514 having a file name test. In an execution result 1102, the ACL 514 of a file test is output. In the execution result 1102, ACEs and their validity periods are outputted.

The command example 1110 indicates an example in which, for the same file test, the ACL 514 is displayed with a period designated. In a command 1111, a period designation parameter 1112 is added in addition to the command 1101. In an execution result 1113, only an entry, a value of the validity period field 5144 of which matches the period designation parameter 1112, of the ACL 514 is output.

The command example 1120 indicates an example in which access right to the file test is changed. A command 1121 executes, on the file test, a setacl command for changing the ACL 514. At this point, in addition to a parameter 1123 for designating setting contents of the user/group field 5141, the processing field 5142, and the possibility field 5143, a parameter 1122 for designating the validity period field 5144 can be designated. In this example, permission of r (reading) and w (writing) is given to a user having a user ID=1003 in a period 2007/01/01 to 2008/12/31. In an execution result 1124, the ACL 514 stored by the file test after a setting change is displayed.

When the period designation parameter 1123 is not designated in the command example 1120, it is possible to validate according to initial setting of the access right changing program 125 whether a change target is only access right at the present point or access right at all points.

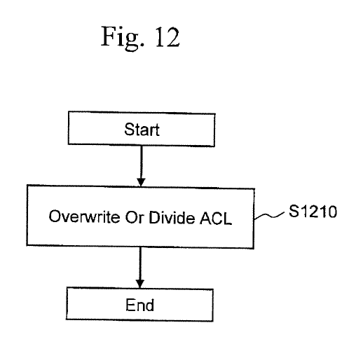

FIG. 12 is a diagram showing a processing flow for changing access right according to the commands explained with reference to FIG. 11. The ACL changing program 1251 executes this processing flow when the user inputs an ACL changing command. The ACL changing program 1251 overwrites an entry instructed to be changed of the ACL 514 using a parameter given by the command and applies information of the entry to the ACL 514 (S1210). When the validity period field 5144 is changed in step S1020, an ACE may be divided as in step S1020.

### First Embodiment

### Summary

As explained above, according to the first embodiment, in the ACL 514 included in the present data set 510 of the file system, access right held by the user at a point in the past is described together with an application period of the access right. Consequently, it is possible to validate, using the present data set 510, whether the user has access right to a past image. The same applies when access right of the user to a past image is changed.

In the first embodiment, the host computer 400 generates the ACL setting screen 910 and the ACL editing screen 920 for displaying or changing the ACL 514 stored in the file system of the file server 100. The user can instruct the file server 100 to collectively change the ACL 514 by, for example, individually changing an ACE or designating a change target period on these screens.

In the first embodiment, the file server 100 can receive the commands explained with reference to FIG. 11 and individually change an ACE or collectively change ACEs matching the designated change target period.

### Second Embodiment

In a second embodiment of the present invention, an operation example performed when the past data set 520 can be updated is explained. The configuration of the computer system 1000 is generally the same as that in the first embodiment. Therefore, differences are mainly explained below.

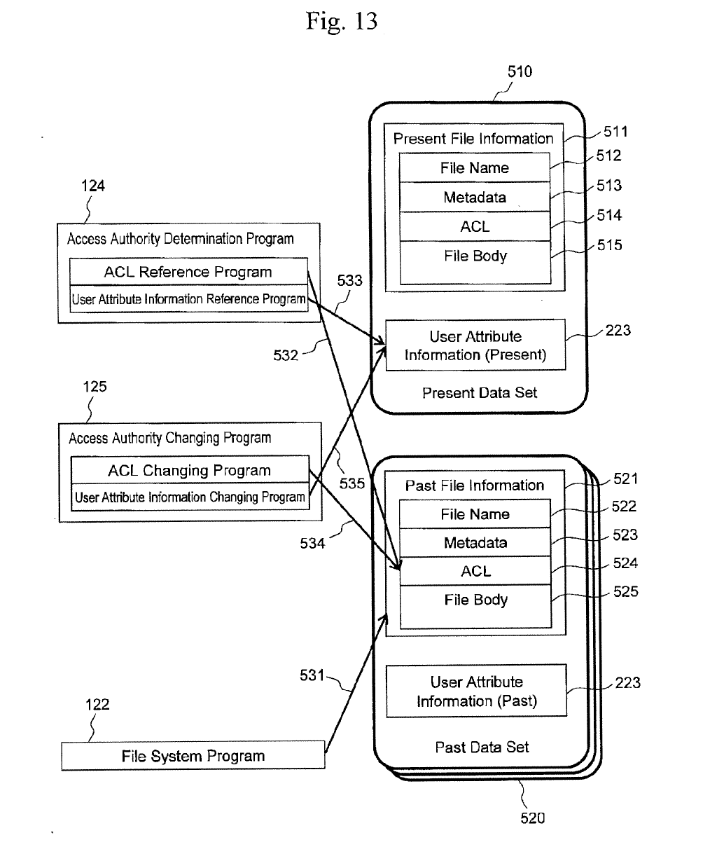

FIG. 13 is a diagram showing reference relations of reference to a file and a past image by computer programs of the file server 100 in a second embodiment. The configurations of the programs and data sets are the same as those shown in FIG. 5 in the first embodiment. However, data referred to by the programs is different from that in the first embodiment.

In the first embodiment, a situation in which the past data set 520 is prohibited to be updated is assumed. However, in the second embodiment, the past data set 520 can be updated. Therefore, the ACL reference program 1241 and the ACL changing program 1251 directly refer to or update the ACL 524 included in the past data set 520. Other reference relations are the same as those in the first embodiment.

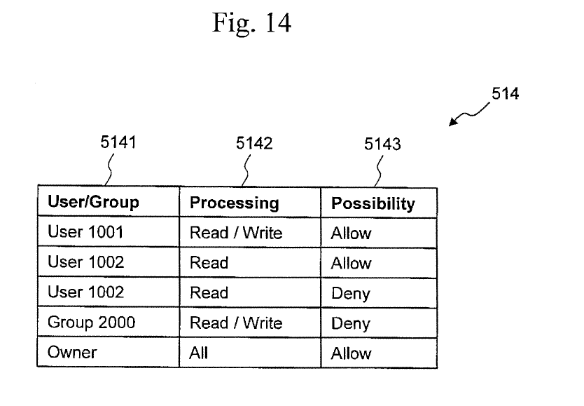

FIG. 14 is a diagram showing a configuration example of the ACL 514 in the second embodiment. The ACL 524 included in the past file information 520 has the same configuration. In the second embodiment, the ACL 524 included in the past file information 520 can be directly referred to or updated. Therefore, it is unnecessary to store information indicating access rights of the past data set 520 in the present data set 510. Therefore, the ACL 514 has a configuration obtained by excluding the validity period field 5144 from the configuration explained with reference to FIG. 6 in the first embodiment.

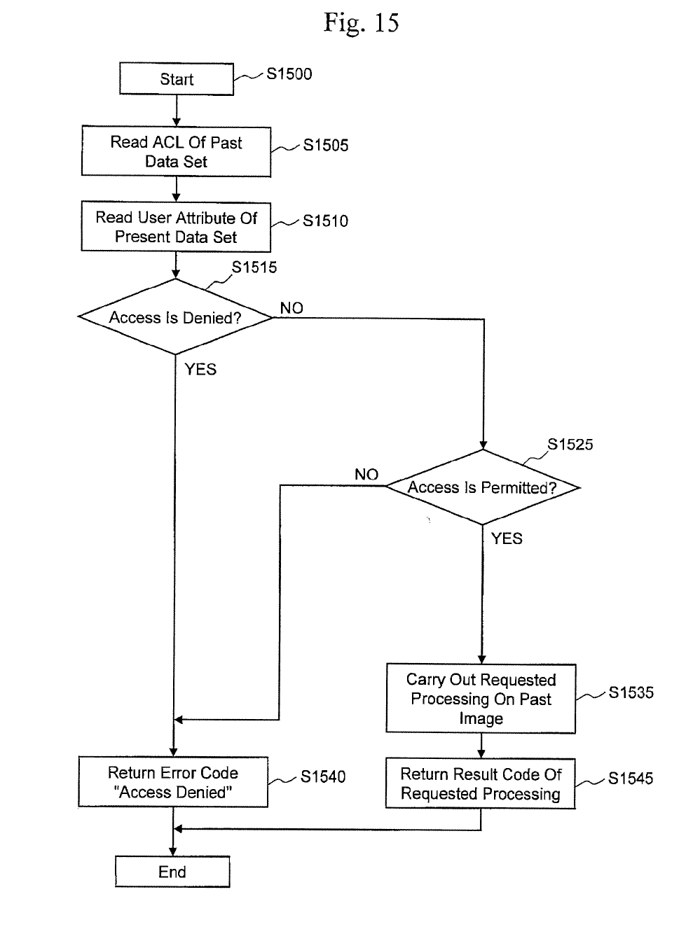

FIG. 15 is a diagram showing a processing flow in which the file server 100 validates accessibility to a past image stored by the file server 100 when the host computer 400 issues an access request to the past image. Steps shown in FIG. 15 are explained below.

(FIG. 15: Steps S1500 to S1505)

A procedure at the start of this processing flow is the same as step S800 shown in FIG. 8 (S1500). The ACL reference program 1241 acquires, from the past data set 520, the ACL 524 of a file requested to be accessed (S1505).

(FIG. 15: Step S1510)

This step is the same as S810 shown in FIG. 8.

(FIG. 15: Step S1515)

The access right validation program 124 validates whether file access is denied using the ACL 524 and the user attribute information 223 obtained in steps S1505 to S1510. Specifically, the access right validation program 124 searches for, in the ACL 524, an entry that has a user who accesses the file or a group to which the user belongs in the user/group field 5241 and in which requested processing coincides with the processing field 5242 and the possibility field 5243 is Deny. When no relevant entry is present, the access right validation program 124 proceeds to step S1525. When a relevant entry is present, the access right validation program 124 proceeds to step S1540.

(FIG. 15: Step S1515: Supplementation)

In the second embodiment, since the programs directly refer to or update the ACL 524 in the past data set 520, a step of checking a validity period field is unnecessary. Therefore, a step equivalent to step S820 is omitted. The same holds true concerning step S830.

(FIG. 15: Step S1525)

The access right validation program 124 validates whether file access is permitted using the ACL 524 and the user attribute information 223 obtained in steps S1505 to S1510. A specific procedure is the same as step S1515 except that an entry in which the possibility field 5243 is Allow is searched. When the access is permitted, the access right validation program 124 proceeds to step S1535. When the access is not permitted, the access right validation program 124 proceeds to step S1540.

(FIG. 15: Steps S1535, S1540, and S1545)

These steps are the same as steps S835, S840, and S845.

It is possible to carry out accessibility validation same as that shown in FIG. 8 according to the processing flow shown in FIG. 15. In the second embodiment, the ACL 524 included in the past data set 520 can be directly referred to or updated. Therefore, instead of describing an ACL in the past in the present ACL 514 using the validity period field 5144, the individual ACL 524 can be stored in the past data set 520 for each point in the past.

The procedure for validating access right to a past image is explained above. Next, a procedure for changing access right to past images is explained.

In the second embodiment, the user of the computer system 1000 can refer to or update the ACL 524 using the ACL setting screen 910 explained with reference to FIG. 9, the command examples 1100 to 1120 explained with reference to FIG. 11, and the like. For example, if the item 9241 is selected in the ACL setting screen 910 of the present data set, the access right changing program 125 only updates the ACL of the present data set. If the item 9242 is selected in the ACL setting screen 910 of the present data set, the access right changing program 125 updates ACLs of all past images along with updating ACL of the present data set. If the item 9242 is selected in the ACL setting screen 910 of the present data set, the access right changing program 125 updates the ACL of the designated past data set.

In addition, in a similar fashion as the embodiment 1, when designating and updating access rights such as using the ACL setting screen 920 or the command example 1120, if the target period is not specified, the initial setting of the access right changing program 125 may determine whether the range of images in which the access right is updated would be limited only to images that are designated in the ACL editing screen 920 or the command example 1120, to all of periods, or to a specific period.

In the second embodiment, since the validity period field 5244 is absent, the field may be displayed or does not have to be displayed in the ACL list display space 911 of the ACL setting screen 910. When the validity period field 5244 is not displayed, the ACL list display space 911 displays only information included in the ACL 524 in a past image of a processing target file. When the validity period field 5244 is displayed, the ACL reference program 1241 acquires the ACL 514 and the ACL 524 at all points from the past to the present, collects ACEs at plural points having the same contents as one entry, and displays a target period of the collection of the ACEs in a space in which the validity period field 5244 should be displayed.

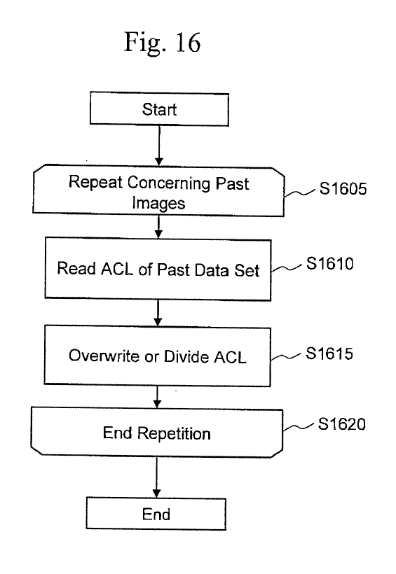

FIG. 16 is a diagram showing a processing flow for changing the ACL 524. The processing flow is executed by the access right changing program 125 when the user of the computer system 1000 changes an ACL using the ACL editing screen 920 and the command examples 1100 to 1120. Steps shown in FIG. 16 are explained below.

(FIG. 16: Steps S1605 and S1620)

The ACL changing program 1251 carries out, concerning past images for which access right is requested to be changed using the ACL editing screen 920 and the command examples 1110 to 1120, each of kinds of processing from the step S1605 to S1620.

(FIG. 16: Step S1610)

The ACL changing program 1251 acquires the ACL 524 of the past data set 520 and acquires, according to necessity, the user attribute information 223 corresponding to the ACL 524 via the user attribute information reference program 1242.

(FIG. 16: Step S1615)

The ACL changing program 1251 applies overwriting of an entry instructed to be changed in the ACL 524 to the ACL 524. The ACL 524 may be divided as in step S1020 shown in FIG. 10.

### Second Embodiment

### Summary

As explained above, the file server 100 according to the second embodiment stores the ACL 524, in which access right to a past image is described, in the past data set 520 and directly refers to or updates the ACL 524. This configuration is effective when various restrictions for prohibiting the past data set 520 from being directly referred to or updated are absent.

In the second embodiment, access right of the user to a past image may be stored in the ACL 514 in the present data set 510 in a superimposed manner. In this case, the file server 100 may refer to or update any one of the ACL 514 and the ACL 524. However, it would be necessary to match contents of the ACL 514 and the ACL 524.

### Third Embodiment

In a third embodiment of the present invention, a method of changing access right to a file in an environment in which a past image creating method called AoW (Allocate on Write) or CoW (Copy on Write) is used is explained. The configuration of the computer system 1000 is generally the same as that in the second embodiment. Therefore, differences related to the AoW or the CoW are mainly explained below.

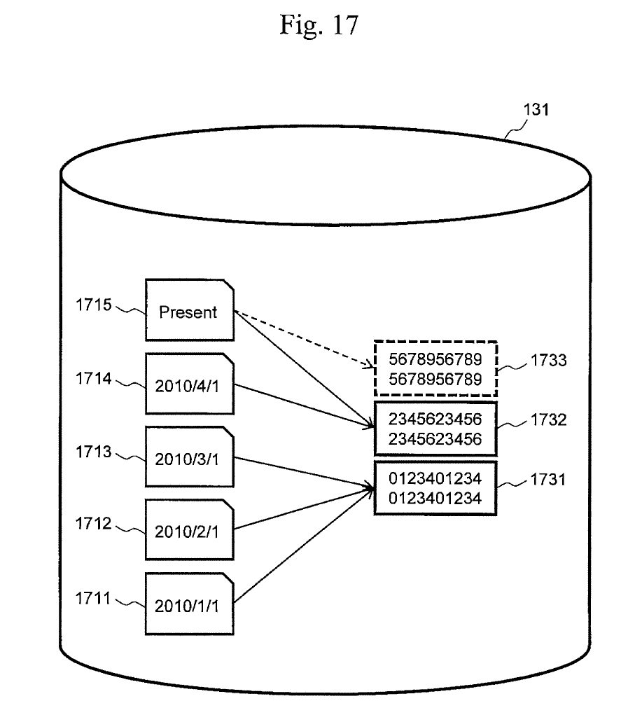

FIG. 17 is a diagram showing a method in which the past image access program 123 updates a past image using the AoW or the CoW. In the following explanation, according to FIG. 17, a procedure for realizing the AoW and the CoW is explained and, thereafter, a procedure for changing access right to a file to which the AoW or the CoW is applied is explained.

In FIG. 17, the storage medium 131 stores, concerning a certain file, a file image in each month according to the elapse of time. The storage medium 131 stores both past image management information 1711 to 1714, which is management information of past images, and present image management information 1715, which is management information of a present image.

The past image management information 1711 to 1714 is pieces of information respectively indicating storage positions in the storage medium 131 in which past images in January to April 2010 are stored. The present image management information 1715 is information indicating a storage position in a storage medium 1700 in which a present file image is stored.

When this file is not altered in a period from January to March 2010, the storage area storing past images in the period from January to March 2010 is shared. The past image management information 1711 to 1713 of these three files designate past image data stored on the same storage area 1731. Since the past image at the point of April 2010 and the present image area sharing the storage area, the past image management information 1714 and the present image management information 1715 designate past image data stored on the same storage area 1732. With this method, since the storage medium 1700 only has to have a single storage area concerning plural file images, there is an advantage that the storage area in the storage medium 131 is not unnecessarily consumed even if past images increase.

When plural file images share a storage area as shown in FIG. 17, it is assumed that it is necessary to modify data on the storage medium 1700 for carrying out writing in the present image, metadata change, ACL change, and the like. Since the present image is stored on the storage area 1732, it is necessary to update the data on the storage area 1732. However, since the storage area 1732 is referred to from the past image management area 1714 as well, the storage area 1732 cannot be directly modified. This is because, if the storage area 1732 is modified, the past image in April 2010 is simultaneously modified. Therefore, a method called AoW or CoW is used.

In the AoW, when a shared storage area is modified, first, a new storage area 1733 is secured and modified data is written in the storage area 1733. A reference destination of the present image management information 1715, which is a modification target, is shifted from the original storage area 1732 to the new storage area 1733, whereby data concerning the present image is modified without affecting other past images.

In CoW, data in the storage area 1732 is copied to another location and a reference destination of past image management information, which refers to the storage area 1732, is modified to a copy destination and then an area originally used by the storage area 1732 is overwritten. The AoW and the CoW are similar in that only modification target image management information is changed not to share a storage area. The access right correcting method explained in the third embodiment can be applied to any system.

When the AoW or the CoW is used, the processing flow explained with reference to FIG. 16 correctly operates. However, since an ACL is rewritten at each point in the past in step S1615, it is likely that a large number of new storage areas are consumed by processing of the AoW or the CoW. Specifically, when plural past images share the same storage area, a new storage area is allocated by the AoW or the CoW every time an ACL is rewritten concerning one point. Therefore, even if contents of a change of the ACL are the same concerning respective points, new storage areas are consumed by a number of points when the ACL is changed.

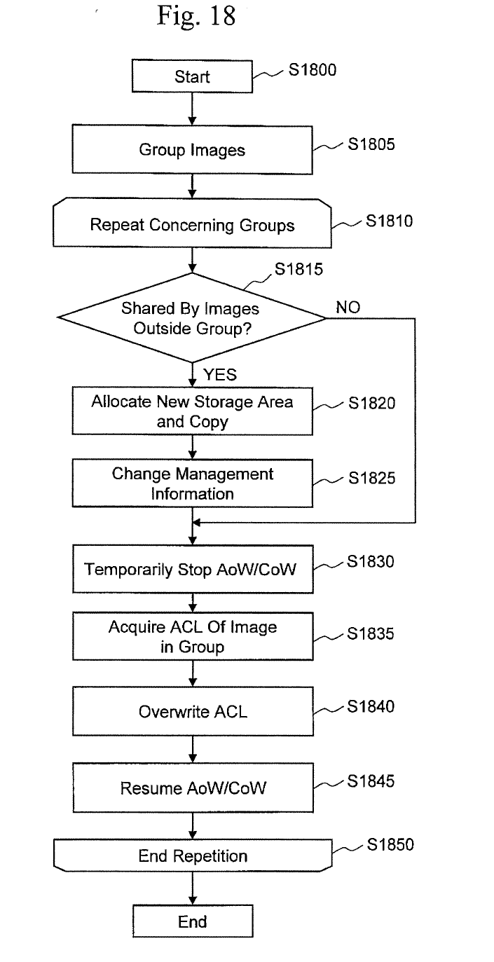

FIG. 18 is a diagram showing a processing flow of an access right change for preventing an amount of use of a storage area from being increased every time an ACL is changed when the AoW or the CoW is used. Steps shown in FIG. 18 are explained below.

(FIG. 18: Step S1800)

When the user of the computer system 1000 instructs an ACL change using the ACL editing screen 920 and the command example 1120, the access right changing program 125 executes steps explained below. This processing flow is executed when the past image access program 123 uses the AoW or the CoW shown in FIG. 17.

(FIG. 18: Step S1805)

The access right changing program 125 groups a present image and past images of a certain file for which an ACL is changed. A criterion for the grouping is that the ACL after the change is the same and refers to the same storage area. With this grouping, a past image group that can share the ACL and the storage area both before and after the change can be collectively processed as one group.

(FIG. 18: Steps S1810 and S1850)

The access right changing program 125 executes steps S1810 to S1850 on groups grouped in step S1805.

(FIG. 18: Step S1815)

The access right changing program 125 determines whether a storage area shared by an image group in a group is shared by an image on the outside of the group as well. When the storage area is shared by the image on the outside of the group as well, the access right changing program 125 proceeds to step S1820. When the storage area is not shared, the access right changing program 125 skips to step S1830.

(FIG. 18: Steps S1820 to S1825)

The access right changing program 125 secures a new storage area on the storage medium 1700 not to overwrite the storage area referred to by the image on the outside of the group and copies contents of an update target storage area to the storage area (S1820). The access right changing program 125 rewrites an image management area in the group to refer to the storage area secured anew rather than the original storage area. According to steps S1820 to S1825, the storage area in which the image in the group is stored does not include the image on the outside of the group.

(FIG. 18: Step S1830)

The access right changing program 125 instructs the past image access program 123 to temporarily stop the AoW/CoW. Consequently, even if a storage area referred to from plural pieces of image management information is rewritten, a new management area is not secured. When a storage area is rewritten, all images that share the storage area and management information of the images are changed.

(FIG. 18: Steps S1835 to S1845)

The ACL changing program 1251 selects one image of the image group in the group and acquires the ACL 524 of the image (S1835). The ACL changing program 1251 reflects contents of access right designated by the user of the computer system 1000 on the acquired ACL 524 and overwrites the ACL 524 (S1840). The access right changing program 125 instructs the past image access program 123 to resume the AoW/CoW (S1845).

### Third Embodiment

### Summary

As explained above, according to the third embodiment, when a past image is stored using the AoW/CoW, it is possible to change access right to a present image and past images without unnecessarily consuming a storage area.

### Fourth Embodiment

In a fourth embodiment of the present invention, an operation example in which accessibility is validated using both the ACL 514 included in the present data set 510 and the ACL 524 included in the past data set 520 is explained. The configuration of the computer system 1000 is generally the same as that in the first to third embodiments. Therefore, differences are mainly explained below.

When user assignment or access right is changed because of, for example, personnel changes of a user in a period to the present after a past image is created by a function such as Snapshot, it is likely that access right intended in the present data set 510 and access right intended in the past data set 520 are different. In this case, there is a problem in that which access right should be treated as valid access right. In the fourth embodiment, ACLs and user attribute information of both the data sets are referred to and compared, whereby it is validated which access right should be finally applied.

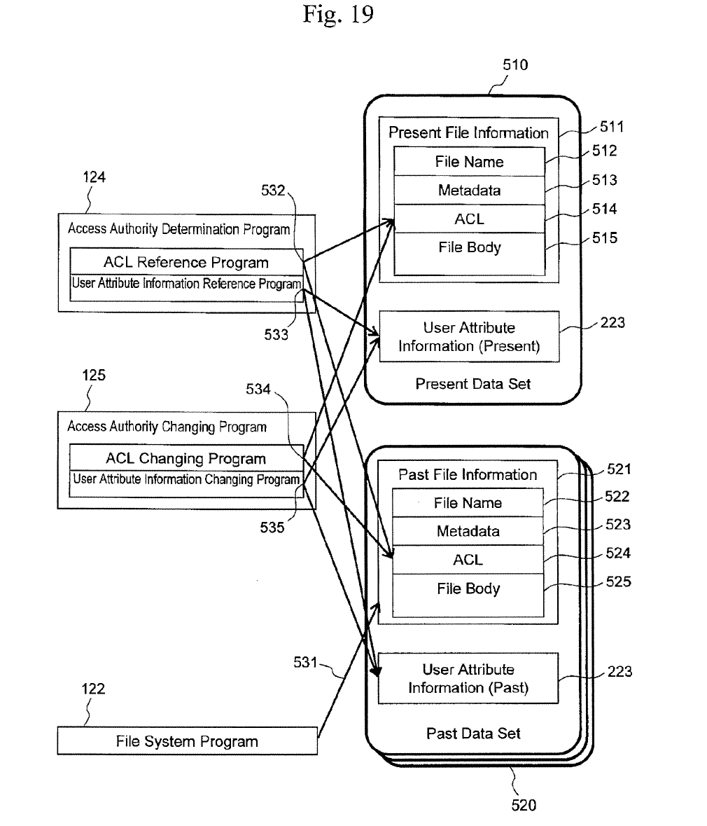

FIG. 19 is a diagram showing reference relations of reference to a file and a past image by computer programs of the file server 100 in the second embodiment. The configurations of the programs and data sets are the same as those shown in FIG. 5 in the first embodiment. However, data referred to by the programs is different from that in the first embodiment.

When the access right validation program 124 validates accessibility to a file, the access right validation program 124 refers to both the ACL 514 and the user attribute information (present) 223 in the present data set 510 and the ACL 524 and the user attribute information (past) 223 in the past data set 520 and compares the ACLs 514 and 524 and the user attribute information (present and past) 223 to validate accessibility. When the access right changing program 125 changes access right to a file, the access right changing program 125 refers to both the ACL 514 and the user attribute information (present) 223 in the present data set 510 and the ACL 524 and the user attribute information (past) 223 in the past data set 520 and changes access right of the ACLs 514 and 524 and the user attribute information (preset and past) 223. Details of these kinds of processing are explained later.

In the fourth embodiment, access right to past images may be managed using the ACL 514 and the user attribute information (present) 223 in the present data set 510 as in the first embodiment or may be managed using the ACL 524 and the user attribute information (past) 223 in the past data set 520 as in the second embodiment. In accessibility validation processing and access right update processing, both the ACLs 514 and 524 and the user attribute information (present and past) 223 are referred to.

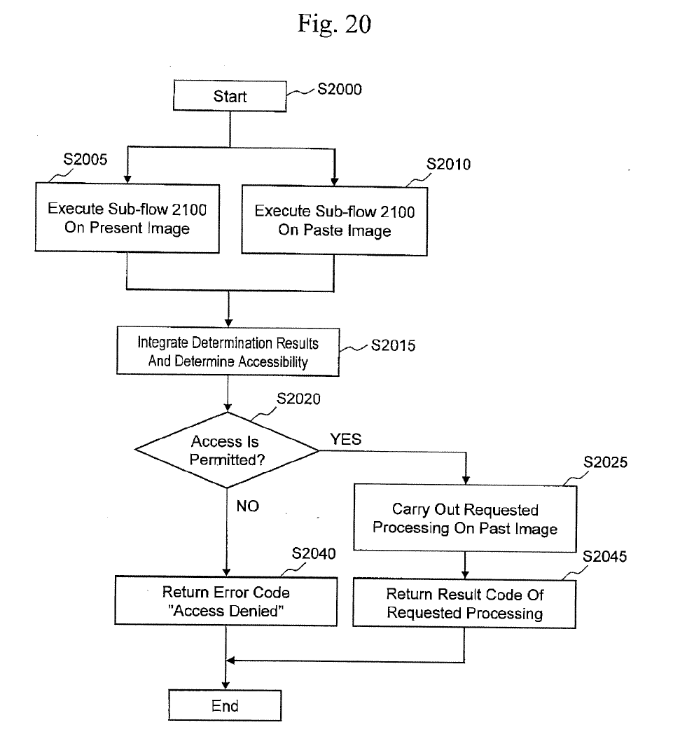

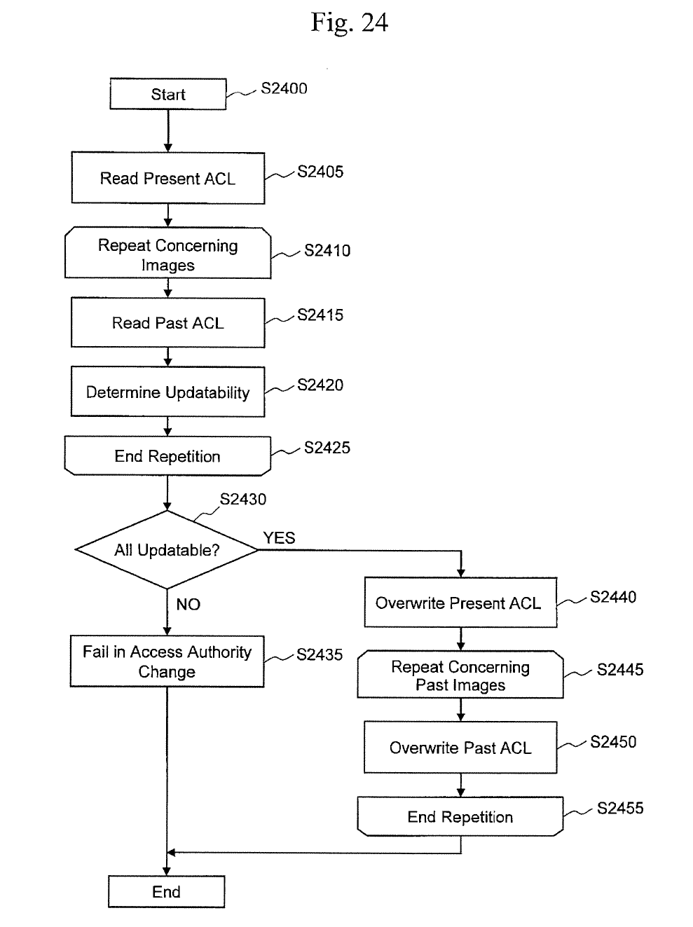

In the following explanation, a procedure of accessibility validation is explained using FIGS. 20 to 22 and a procedure of access right update is explained using FIGS. 23 and 24.

### Fourth Embodiment

### Accessibility Validation

FIG. 20 is a diagram showing a processing flow at the time when the host computer 400 requests access to past images on the file server 100. Steps shown in FIG. 20 are explained below.

(FIG. 20: Step S2000)

When the host computer 400 requests access to a past image on the file server 100, the file system program 122 inquires the access right validation program 124 about accessibility. The access right validation program 124 validates accessibility by executing steps explained below.

(FIG. 20: Steps S2005 to S2010)

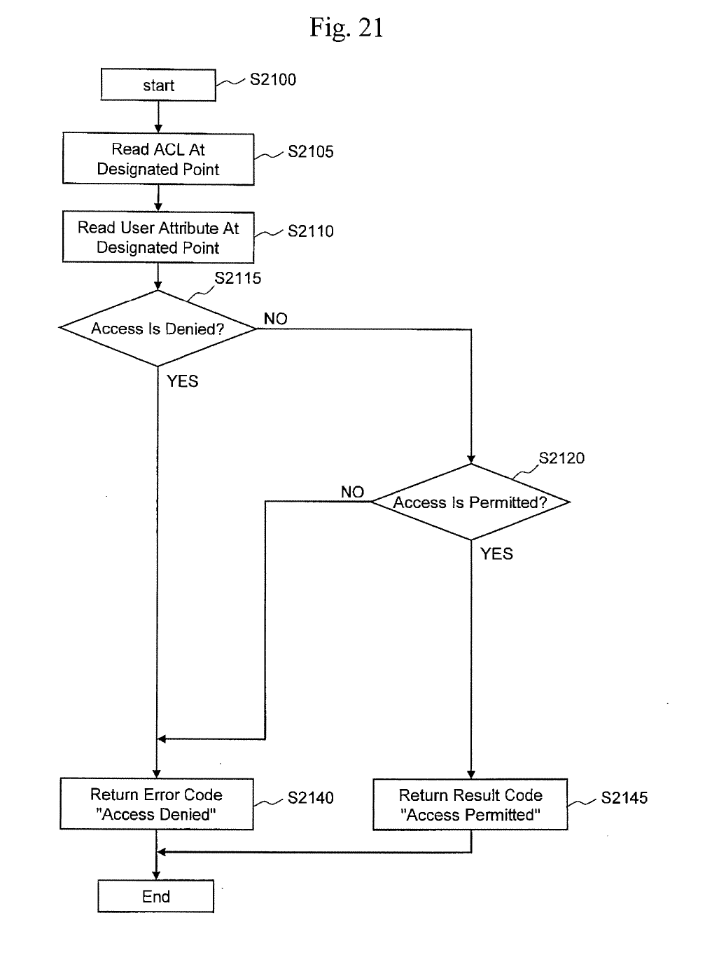

The access right validation program 124 executes, on a present image, an access validation sub-flow 2100 explained with reference to FIG. 21 later (S2005). Simultaneously with or continuously from the execution of the access validation sub-flow 2100, the access right validation program 124 executes the access validation sub-flow 2100 on a past image to be accessed (S2010).

(FIG. 20: Steps S2005 to S2010: Supplementation)

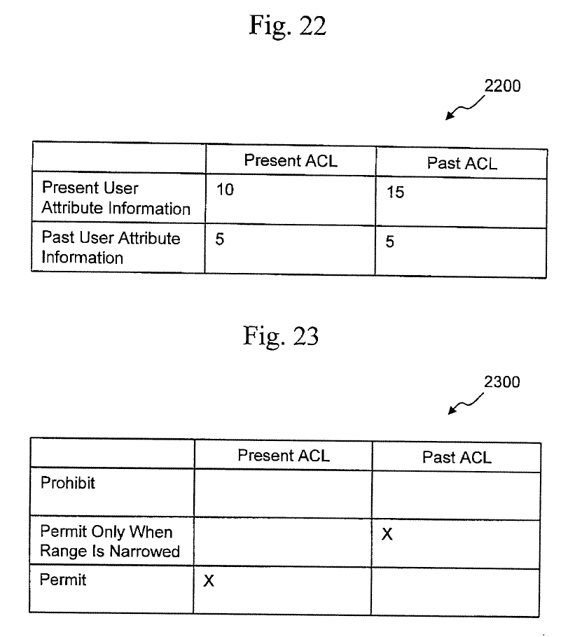

The access validation sub-flow 2100 may be carried out two or more times. For example, as shown in FIG. 22 referred to later, four kinds of sub-flows 2100 in total may be executed according to combinations of the ACL 514 of the present image and the ACL 524 of the past image, as ACLs, and the user attribute information 223 of the present image and the user attribute information 223 of the past image. The present image and a past period set as an access target may be divided and the sub-flow 2100 may be executed at respective points. For example, when a past image of three months before is referred to, it is conceivable to execute the sub-flow 2100 concerning four points of the present, one month before, two months before, and three months before.

(FIG. 20: Step S2015)

The access right validation program 124 receives a result of the access validation sub-flow 2100 for the present image and a result of the access validation sub-flow 2100 for the past image at the access target point and validates final accessibility. If both the validation results are the same, the access right validation program 124 directly uses the validation results. When the validation results are different from each other, the access right validation program 124 determines, according to a predetermined validation criterion, which of the validation results is used. As an example of the validation criterion in this case, validation criteria explained below are conceivable.

(FIG. 20: Step S2015; Validation Criterion Example No. 1)

When the access validation result for the present image and the access validation result for the past image are different, access right applied to a narrower range is given priority. For example, it is assumed that an ACE indicating that access is denied for a group to which the user belongs is present in the ACL 524 of the past image and an ACE for permitting access for the same user is present in the ACL 514 of the present image. The former is access right for the group and the latter is access right for the individual user. Therefore, it can be said that a range of application of an ACL is narrower in the latter. In this case, the access right validation program 124 considers that the ACL having a narrower application range has stronger compelling force and finally permits access.

(FIG. 20: Step S2015: Validation Criterion Example No. 2)

It is assumed that a file owner of the present image and a user who accesses the file are different and an ACE indicating that access is denied for the user who accesses the file is present in the present ACL 514. In this case, the file owner is considered to have an intention of not allowing the user to refer to the file. Therefore, the validation result concerning the present image is given priority over the validation result concerning the past image.

(FIG. 20: Step S2015: Validation Criterion Example No. 3)

A validation criterion may be changed for each user who accesses a file. For example, when a user who accesses the file is a user having strong right such as an administrator, the user can refer to both the present image and the past image if the user obtains access permission for one of the images. In the case of a general user not having strong right, the user cannot refer to both the present image and the past image unless the user obtains access permission concerning both the images. It only has to be validated as appropriate, according to, for example, specifications of the computer system 1000, to a user having which degree of right this criterion is applied. In any case, this criterion would be applied to some privileged user.

(FIG. 20: Step S2015: Validation Criterion Example No. 4)

As explained with reference to FIG. 22 later, four patterns are formed according to combinations of the present ACL 514, the user attribute information 223 (present), the past ACL 524, and the user attribute information 223 (past). Scores are given to the patterns and priority is given to a combination having a higher score.

(FIG. 20: Steps S2020 to S2045)

These steps are the same as steps S1525 to S1545 shown in FIG. 15.

FIG. 21 is a processing flowchart of the access validation sub-flow 2100 carried out in steps S2005 and S2010 of FIG. 20. Steps shown in FIG. 21 are explained below.

(FIG. 21: Step S2105)

The ACL reference program 1241 acquires the ACL 514 or the ACL 524 at a point set as an access target from the present data set 510 or the past data set 520.

(FIG. 21: Step s2110)

The user attribute information reference program 1242 acquires the user attribute information 223 at the point set as the access target from the present data set 510 or the past data set 520 and acquires a user ID of a user who requests access to a file, user attribute information matching a point when access is requested, and group attribute information to which the user ID belongs at a designated point.

(FIG. 21: Step S2115)

The access right validation program 124 carries out processing same as step S1515 using the ACL and the user attribute information 223 obtained in steps S2105 to S2110. When no relevant entry is present, the access right validation program 124 proceeds to step S2120. When a relevant entry is present, the access right validation program 124 proceeds to step S2140.

(FIG. 21: Step S2120)

The access right validation program 124 carries out processing same as step S1525 using the ACL 524 and the user attribute information 223 obtained in steps S2105 to S2110. When access is permitted, the access right validation program 124 proceeds to step S2145. When access is not permitted, the access right validation program 124 proceeds to step S2140.

(FIG. 21: Steps S2140 to S2145)

The access right validation program 124 returns a result of the access validation as a result code. The access right validation program 124 can return a validation reason in addition to the result code. The access right validation program 124 may return, for example, contents of an ACE set as a validation criterion.

FIG. 22 is a diagram showing a configuration example of a score table 2200 used when the validation result of access to the present image and the validation result of access to the past image are different in step S2015. The score table 2200 may be stored in a storage medium such as the memory 120 as a data table or may be described in a program such as the access right validation program 124.

In the score table 2200, a score representing a priority degree is described for each combination pattern of a present ACL, a past ACL, present user attribute information, and past user attribute information. For example, when the validation result of access to the present image and the validation result of access to the past image are different in step S2015, the access right validation program 124 validates accessibility using a combination having a largest score among these four patterns.

The administrator of the computer system 1000 sets in advance scores stored in the score table 2200 according to, for example, characteristics of the system. For example, it is considered rare to validate access right to the present image using user attribute information at a point in the past. Therefore, a criterion for setting a score low concerning a combination of the present ACL and the past user attribute information is conceivable.

The score table 2200 is not limited to the configuration example shown in FIG. 22 and can adopt various configurations. For example, any one of the scores may be 0. In this case, a validation result is neglected concerning a combination pattern of the score 0. Contents of the score table 2200 may be changed for each condition. For example, a different score table may be provided for each file or user. Besides, a different score may be allocated according to a validation result of the sub-flow 2100. For example, a higher score can be given to a result obtained by validating accessibility using an ACL concerning users in a narrower range.

### Fourth Embodiment

### Access Right Change

In the fourth embodiment, the user of the computer system 1000 can refer to or update the ACL 524 using the ACL setting screen 910 explained with reference to FIG. 9, the command examples 1100 to 1120 explained with reference to FIG. 11, and the like. Treatment of a valid period field is the same as that in the second embodiment.

In the accessibility validation flow explained with reference to FIG. 20, accessibility is valiadted using the ACL 514 of the present data set 510 and the ACL 524 of the past data set 520. Therefore, when access right to the past image is changed, both the ACL 514 of the present image and the ACL 524 of the past image need to be changed to match contents thereof.

However, depending on a writing restriction on a storage medium or a legal restriction, both the ACL 514 and the ACL 524 cannot always be changed. For example, in some case, rewriting of the past ACL 524 is prohibited by a legal restriction. Therefore, in the fourth embodiment, it is regulated using an ACL updatability table 2300 shown in FIG. 23 in which range each of the present ACL 514 and the past ACL 524 can be updated.

FIG. 23 is a diagram showing a configuration example of the ACL updatability table 2300. The ACL updatability table 2300 may be stored in a storage medium such as the memory 120 as a data table or may be described in a program such as the access right changing program 125.

The ACL updatability table 2300 defines, concerning each of the present ACL 514 and the past ACL 524, three types of updatability, i.e., update is prohibited, only update for narrowing a range is permitted, and update is permitted. In a data example shown in FIG. 23, it is designated that update is permitted concerning the present ACL 514 and only update for narrowing a range is permitted concerning the past ACL 524.

The ACL updatability table 2300 is not limited to the configuration example shown in FIG. 23 and can adopt various configurations. For example, concerning the past ACL 524, a period may be subdivided and updatability may be separately set for each period. As a case in which update is permitted, an example other than the updatability for permitting only update for narrowing a range may be defined. The ACL updatability table 2300 may be provided, for example, for each file system, each folder, or each file.

FIG. 24 is a diagram showing a processing flow for changing access right in the fourth embodiment. Steps shown in FIG. 24 are explained below.

(FIG. 24: Step S2400)

When the user of the computer system 1000 instructs the computer system 1000 to change an ACL using the ACL editing screen 920, the command example 1120, and the like, the access right changing program 125 starts this processing flow.

(FIG. 24: Steps S2405, S2410, and S2425)

The access right changing program 125 acquires the ACL 514 of a present image (S2405). The access right changing program 125 carries out steps S2415 to S2420 concerning past images at points set as change targets.

(FIG. 24: Steps S2415 to S2420)

The access right changing program 125 reads the ACL 524 of a past image (S2415). The access right changing program 125 collates the ACL 514 of the present image and the ACL 524 of the past image and validates according to a description of the ACL updatability table 2300 whether it is permitted to rewrite the ACL 514 of the present image and the ACL 524 of the past image.

(FIG. 24: Steps S2415 to S2420: supplementation)

In some case, access right can be changed simply by changing any one of the ACL 514 of the present image and the ACL 524 of the past image. For example, when accessibility is validated using the score table 2200 explained with reference to FIG. 22, a combination having a high score is finally given priority. Therefore, it is sufficient to change access right concerning only a combination having a highest score. In this case, the access right changing program 125 does not always need to update all ACLs set as change targets. For example, the administrator of the computer system 1000 can update only a part of the ACLs according to setting decided beforehand or minimize the number of ACEs to be changed. A priority degree may be described in the ACL updatability table 2300 beforehand and an ACL to be changed may be selected on the basis of the priority degree.

(FIG. 24: Step S2430)

When a past image, access right of which cannot be updated in the loop of steps S2410 to S2425, is present, the access right changing program 125 proceeds to step S2435. When access right can be updated concerning all paste images, the access right changing program 125 proceeds to step S22440.

(FIG. 24: Step S2435)

The access right changing program 125 validates that the access right cannot be changed, returns an error code indicating that the access right changing program 125 fails in the change of the access right, and ends this processing flow.

(FIG. 24: Step S2440)

When the access right changing program 125 determines in step S2420 that it is necessary to change the ACL 514 of the present image, the access right changing program 125 overwrites the ACL 514 of the present image with the ACL after the change.

(FIG. 24: Steps S2445 and S2455)

The access right changing program 125 carries out the processing of the step S2445 to S2455 concerning paste images for which access right is changed.

(FIG. 24: Step S2455)

When the access right changing program 125 determines in step S2420 that it is necessary to change the ACL 524 of the past image, the access right changing program 125 overwrites the ACL 524 of the past image with the ACL after the change.

### Fourth Embodiment

### Summary

As explained above, according to the fourth embodiment, when accessibility to the past image is validated, it is possible to compare accessibility to the present image and accessibility to the past image and validate final accessibility. Consequently, even when an ACL is changed in a period to the present after access right to the past image is set, it is possible to appropriately validate accessibility.

According to the fourth embodiment, even when it is restricted to change the ACL 524 of the past image according to characteristics of a storage medium or a demand of a law, it is possible to update an ACL within a range of the restriction by updating the ACL according to the description of the ACL updatability table 2300.

### Fifth Embodiment

In a fifth embodiment of the present invention, an operation example for presenting, when a user does not have access right to a desired file image, as an alternative, another file image that the user can access is explained. The configuration of the computer system 1000 according to the fifth embodiment is generally the same as that in the first to fourth embodiments. Therefore, differences are mainly explained below.

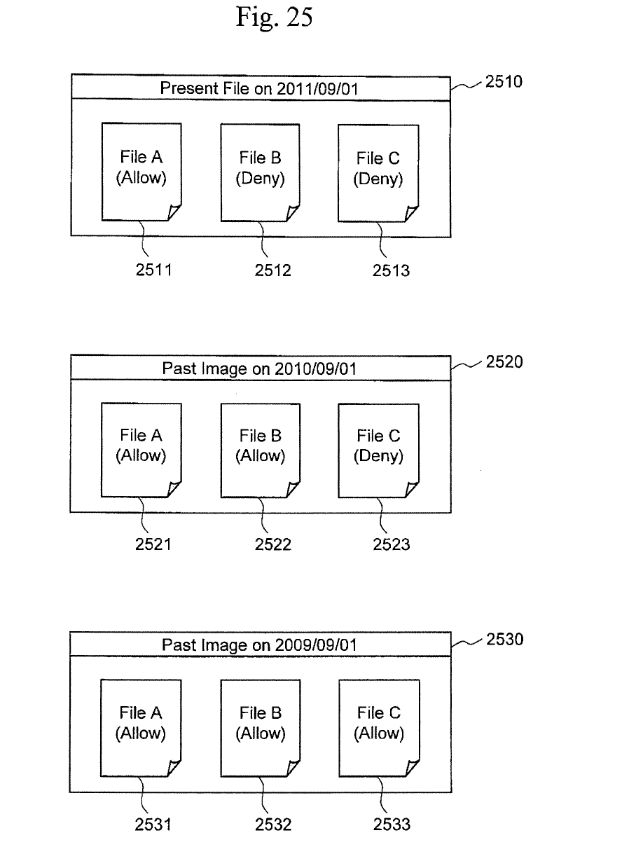

FIG. 25 is a diagram showing a state in which a file list in a folder stored by the file server 100 is screen-displayed on the host computer 400. Since the file server 100 stores past images corresponding to a present image, the present image and the past images can be displayed as a list on the host computer 400. A file group 2510 stored by a present data set, a file group 2520 stored by a past data set of one year before, and a file group 2530 stored by a past data set of two years before are shown as examples. File names and accessibility are displayed together in a screen that displays the file groups.

In some case, the user has different access right depending on a point of a data set even if a file is the same. In the example shown in FIG. 25, concerning a present image 2511 of a file A and past images 2521 and 2531 of the present image 2511, the user has the same access right (Allow). Concerning a file B, the user does not have access right to a present image 2512 (Deny) but has access right to past images 2522 and 2532 (Allow). Concerning a file C, the user does not have access right to a present image 2513 and a past image 2523 (Deny) but has access right to a past image 2533 (Allow).

In an environment shown in FIG. 25, when access to a present image by the user is denied, even if the user has access right to any one of past images, the user has to search for, referring to plural past images, a data set for which the user has access right. Therefore, in the fifth embodiment, a virtual file list view for providing an image at a point when the user has access right is provided.

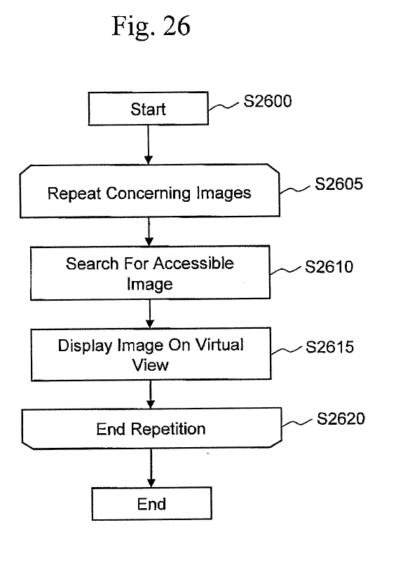

FIG. 26 is a diagram showing a processing flow for generating a virtual file list view. Steps shown in FIG. 26 are explained below.

(FIG. 26: Step S2600)

When the user of the computer system 1000 requests, on the host computer 400, the computer system 1000 to acquire file information on a file system or in a folder, the file system program 122 executes steps explained below while making use of functions of the past image access program 123 and the access right validation program 124.

(FIG. 26: Steps S2605 and S2620)

The file system program 122 executes processing of steps S2605 to S2620 concerning files from which file information is acquired.

(FIG. 26: Step S2610)

The file system program 122 retrieves, using attribute information of a user who requests acquisition of file information, an image that the user can access among a present image and a past image group of files.

(FIG. 26: Step S2610: supplementary)

In this step, the file system program 122 may date back file images in time series from a present image to a past image and check accessibility to the file images one by one or may use binary search for an image or a procedure for, for example, storing previous validation results and reusing the validation results. The number of file images retrieved in this step is not limited to one. All file images that the user can access may be listed or only a file image group at timing when data in the file image is changed may be extracted.

(FIG. 26: Step S2615)

The file system program 122 screen-displays, in the virtual file list view, an icon or the like indicating an image group retrieved in step S2610.

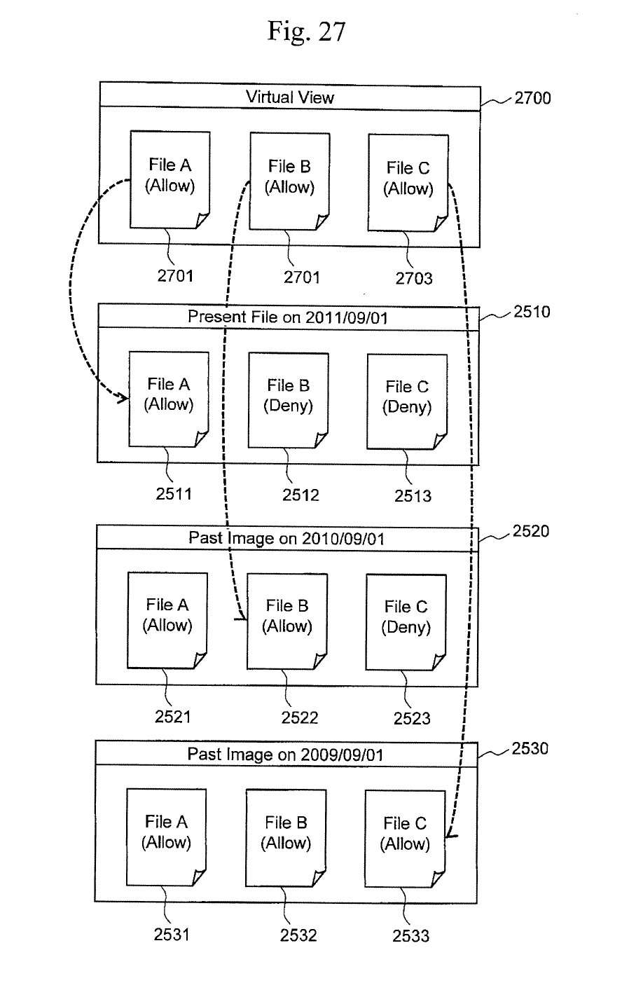

FIG. 27 is a diagram showing a screen display example of a virtual file list view 2700. The virtual file list view 2700 displays virtual file images 2701, 2702, and 2703.

The virtual file images correspond to a latest file image that a user who requests acquisition of file information can access among a present image and past images of files. The virtual file image 2701 represents the present image 2511 of the file A. The virtual file image 2702 represents the latest past image 2522 for which the user has access right among the past images of the file B. The virtual file image 2703 represents the latest past image 2533 for which the user has access right among past images of the file C.

All the virtual file images 2701 to 2703 in the virtual file list image 2700 provide virtual file images corresponding to file images that the user can access. Therefore, the user can access a file image for which the user has access right without retrieving a file image that the user can access.

In FIGS. 25 and 27, file lists are represented by icons. For example, the file lists may be represented by characters. In FIGS. 25 and 27, it is explained that a latest file image for which the user has access right is specified. However, the same method can be used when past images are dated back concerning a single file image and all past images for which the user has access right are listed.

### Fifth Embodiment

### Summary

As explained above, according to the fifth embodiment, even when a user does not have access right to a present image, it is possible to retrieve a past image to which the user has access right out of past images and present the past image to the user. Consequently, the user does not need to consume labor and time for searching for a past image to which the user has access right out of the past images. This is convenient for the user.

### REFERENCE SIGNS LIST

100 file server
110 CPU
120 memory
121 network file processing program
122 file system program
123 past image access program
124 access right validation program
125 access right changing program
126 buffer cache
130 storage interface
131 storage medium
132 external storage
140 network interface
200 user attribute information server
210 CPU
220 memory
221 user attribute information management program
222 past user attribute information access program
223 user attribute information
2231 user ID field
2232 account name field
2233 password field
2234 user name field
2235 validity period field
2236 group ID field
2237 group name field
2238 member user list field
2239 validity period field
230 network interface
300 network
400 host computer
410 CPU
420 memory
421 application program
422 network file system client program
430 network interface
510 present data set
511 present file information
512 file name
513 metadata
514 ACL
5141 user/group field
5142 processing field
5143 possibility field
5144 validity period field
515 file body
520 past data set
521 past file information
522 file name
523 metadata
524 ACL
525 file body
910 ACL setting screen
920 ACL editing screen
1000 computer system
1100 to 1120 command examples
1711 to 1714 past image management information
1715 present image management information
1731 to 1733 storage areas
2200 score table
2300 ACL updatability table
2510 to 2530 file groups
2700 virtual file list view

1. A computer comprising:
a storing unit that stores a data file; and
a processor that reads out the data file from the storing unit, wherein the storing unit stores
a past image that is a past version of the data file, and
a present access control list in which access right of a user to the data file and access right of a user to the past image are described, and
when the processor receives an access request to the past image from the user, the processor reads out access right of the user to the past image from the present access control list and validates, according to a description of the present access control list, whether the user has right for accessing the past image.

2. The computer according to claim 1, wherein
the present access control list describes a period in which the access right of the user to the past image is applied, and
when the processor receives an access request to the past image at a certain point in the past from the user, the processor reads out access right of the user to the past image at the point from the present access control list and validates, according to a description of the present access control list, whether the user has right for accessing the past image at the point, and
if the processor is not able to read out access right of the user to the past image at the point from the present access control list, the processor determines that the user doesn't have right for accessing the past image at the point.

3. The computer according to claim 1, wherein the processor receives a period set as a target for rewriting the access right of the user to the past image and contents of the rewriting, and collectively rewrites contents of the present access control list corresponding to the period according to the rewriting contents.

4. A computer comprising:
a storing unit that stores a data file; and
a processor that reads out the data file from the storing unit, wherein the storing unit stores
a past image that is a past version of the data file,
a present access control list in which access right of a user to the data file is described, and
a past access control list in which access right of a user to the past image is described, and
when the processor receives the period set as the target for rewriting the access right of the user to the past image and the contents of the rewriting as a rewriting request for the past access control list, the processor rewrites the contents of the past access control list corresponding to the period according to the rewriting contents, and
when the processor receives an access request to the past image from the user, the processor reads out access right of the user to the past image from the past access control list and validates, according to a description of the past access control list, whether the user has right for accessing the past image.

5. The computer according to claim 1, wherein
if contents of the data file and two or more images among a plurality of the past images respectively corresponding to different periods are the same, the storing unit stores the data file or the past images while a same storage area being shared by the data file or the past images,
when the data file or the past images that share the storage area are updated, the processor releases the sharing concerning the data file or the past images to be updated, secures a new storage area, and stores data that is an update target and data that is not an update target on different storage areas, and
when a request for updating access right of the user to the past image that shares a storage area with the data file or the other past images is received, the processor specifies the data file and the past image that share the storage area, temporarily suspends processing for releasing the sharing concerning the specified data file and the specified past image and updates the access right in a state in which the data file and the past image share the storage area, and thereafter resumes the processing for releasing the sharing.

6. The computer according to claim 5, wherein
the processor
specifies the data file and the past images that share the storage area and specifies the data file and the past images to which access right after the update is the same,
collects, as groups, the data file and the past images that share the storage area and to which the access right after the update is the same, and
concerning the group that shares the storage area with the other groups, allocates a new storage area and copies the data file and the past image included in the group before temporarily suspending the processing for releasing the sharing.

7. A computer comprising:
a storing unit that stores a data file; and
a processor that reads out the data file from the storing unit, wherein the storing unit stores
a past image that is a past version of the data file,
a present access control list in which access right of a user to the data file is described, and
a past access control list in which access right of a user to the past image is described, and
if the access right described in the present access control list and the access right described in the past access control list coincide with each other, the processor validates accessibility according to coinciding contents of the access right, and
if the access right described in the present access control list and the access right described in the past access control list do not coincide with each other, the processor compares the access rights and determines to which of the access rights priority should be given.

8. The computer according to claim 7, wherein
if the access right described in the present access control list and the access right described in the past access control list do not coincide with each other, the processor gives priority to the access right applied to a narrower range of users among users to whom the access right described in the present access control list is applied and users to whom the access right described in the past access control list is applied.

9. The computer according to claim 7, wherein
if the access right described in the present access control list and the access right described in the past access control list do not coincide with each other,
if the user is a privileged user, the processor permits access to the past image if a description to the effect that access to the past is permitted is present in any one of the present access control list and the past access control list and, if the user is a general user, the processor does not permit access to the past image unless a description to the effect that access to the past image is permitted is present in both the present access control list and the past access control list.

10. The computer according to claim 7, wherein
the storing unit stores a score table in which a present access control list priority degree representing a degree that priority is given to the present access control list and a past access control list priority degree representing a degree that priority is given to the past access control list are described, and
if the access right described in the present access control list and the access right described in the past access control list do not coincide with each other, the processor calculates a priority degree of the present access control list and a priority degree of the past access control list using the score table and validates accessibility to the data file or the past image according to a result of the calculation.

11. The computer according to claim 10, wherein
in the score table, the present access control list priority degree and the past access control list priority degree are described for each combination pattern of the present access control list, attribute information of a user to whom the present access control list is applied, the past access control list, and attribute information of the user at a point when the past access control list is applied, and
if the access right described in the present access control list and the access right described in the past access control list do not coincide with each other, the processor acquires attribute information of the user at a point set as a target of an access request, calculates a priority degree of the present access control list using the attribute information of the user to whom the present access control list is applied and the present access control list and calculates a priority degree of the past access control list using the attribute information of the user at the point when the past access control list is applied and the past access control list, and validates accessibility to the data file or the past image according to a result of the calculation.

12. The computer according to claim 7, wherein
the storing unit stores an access control list updatability table for defining whether it is permitted to update each of the present access control list and the past access control list, and
when the processor receives a request for updating the present access control list or the past access control list, the processor determines possibility of the update according to a description of the access control list updatability table.

13. The computer according to claim 12, wherein
the access control list updatability table defines possibility of update of the past access control list for each period in which access right of the user to the past image is specified on the past access control list, and
when the processor receives a request for updating access right to the past image at a certain point in the past, the processor determines possibility of update at that point according to a description of the access control list updatability table.

14. The computer according to claim 1, wherein
when the processor receives an access request to the data file or the past image,
the processor
validates, referring to the present access control list and the past access control list, whether a user has access right to the data file and whether the user has access right to the past images corresponding to the data file,
presents the data file to the user if the user can access the data file, and presents, if the user cannot access the data file, the past image at a point when the user has access right among past images corresponding to the data file to the user.
